(19) United States
(12) Patent Application Publication
(10) Pub. No.: US 2024/0430068 A1
(43) Pub. Date: Dec. 26, 2024

(54) TRANSMISSION CONFIGURATION STATE SELECTION FOR PERIODIC WIRELESS COMMUNICATIONS WITH MULTIPLE BEAM INDICATIONS

(71) Applicant: QUALCOMM Incorporated, San Diego, CA (US)

(72) Inventors: Mostafa KHOSHNEVISAN, San Diego, CA (US); Yan ZHOU, San Diego, CA (US); Fang YUAN, Beijing (CN); Tao LUO, San Diego, CA (US); Xiaoxia ZHANG, San Diego, CA (US)

(21) Appl. No.: 18/709,240

(22) PCT Filed: Jan. 19, 2022
(86) PCT No.: PCT/CN2022/072731

§ 371 Date: May 10, 2024

(51) Int. Cl. H04L 5/00; H04B 7/06; H04W 72/0446

(52) U.S. Cl. CPC H04L 5/0094; H04B 7/0626; H04W 72/0446

(57) ABSTRACT

Methods, systems, and devices for wireless communications are described for configuration of multiple transmission configuration indicator (TCI) states and selection of a particular TCI state or TCI states for different instances of scheduled periodic communications between a user equipment (UE) and one or more transmission-reception points (TRPs) or base stations. A UE may receive, from a network entity, control signaling identifying two or more TCI states that are to be applied to communications of one or more channels subsequent to a determined time. The network entity may also provide a periodic communication configuration with a series of resource allocations for periodic communications, and a selection indication for which of the two or more TCI states are to be selected for the periodic communications. The UE may communicate via the one or more channels according to one or more TCI states based on the selection indication.

### CROSS REFERENCE

The present application is a 371 national phase filing of International PCT Application No. PCT/CN2022/072731 by KHOSHNEVISAN et al., entitled “TRANSMISSION CONFIGURATION STATE SELECTION FOR PERIODIC WIRELESS COMMUNICATIONS WITH MULTIPLE BEAM INDICATIONS,” filed Jan. 19, 2022, which is assigned to the assignee hereof, and which is expressly incorporated by reference in its entirety herein.

### FIELD OF TECHNOLOGY

The following relates to wireless communications, including transmission configuration state selection for periodic wireless communications with multiple beam indications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some systems, UEs and base station may use one or more beam configurations for communications. Such beam configurations may be indicated by a transmission configuration indicator (TCI) state, where a UE and base station may use one or more TCI states for uplink communications, downlink communications, or both. Efficient techniques for managing TCI states for communications may help to enhance communications efficiency and reliability, and may reduce communications latency.

### SUMMARY

The described techniques relate to improved methods, systems, devices, and apparatuses that support transmission configuration indicator (TCI) state selection for periodic wireless communications with multiple beam indications. In accordance with various aspects, techniques are described for configuration of multiple TCI states and selection of a particular TCI state or TCI states for different instances of scheduled periodic communications between a user equipment (UE) and one or more transmission-reception points (TRPs) or base stations. In some cases, a UE may receive, from a network entity (e.g., a base station or TRP), control signaling identifying two or more TCI states that are to be applied to communications of one or more channels subsequent to a determined time. The network entity may also provide a periodic communication configuration with a series of resource allocations for periodic communications, and a selection indication for which of the two or more TCI states are to be selected for the periodic communications. The UE may communicate (e.g., with a base station via one or more TRPs) via the one or more channels according to at least one of the two or more TCI states based at least in part on the selection indication.

A method for wireless communication at a user equipment (UE) is described. The method may include receiving, from a network entity, control signaling identifying two or more transmission configuration indicator states that are to be applied to communications of one or more channels subsequent to a determined time, receiving, from the network entity, a periodic communication configuration that provides a series of resource allocations for periodic communications and a selection indication for which of the two or more transmission configuration indicator states are to be selected for the periodic communications, and communicating via the one or more channels according to at least one of the two or more transmission configuration indicator states based on the selection indication.

An apparatus for wireless communication at a UE is described. The apparatus may include at least one processor; and memory coupled with the at least one processor, the memory storing instructions executable by the at least one processor to cause the apparatus to receive, from a network entity, control signaling identifying two or more transmission configuration indicator states that are to be applied to communications of one or more channels subsequent to a determined time, receive, from the network entity, a periodic communication configuration that provides a series of resource allocations for periodic communications and a selection indication for which of the two or more transmission configuration indicator states are to be selected for the periodic communications, and communicate via the one or more channels according to at least one of the two or more transmission configuration indicator states based on the selection indication.

Another apparatus for wireless communication at a UE is described. The apparatus may include means for receiving, from a network entity, control signaling identifying two or more transmission configuration indicator states that are to be applied to communications of one or more channels subsequent to a determined time, means for receiving, from the network entity, a periodic communication configuration that provides a series of resource allocations for periodic communications and a selection indication for which of the two or more transmission configuration indicator states are to be selected for the periodic communications, and means for communicating via the one or more channels according to at least one of the two or more transmission configuration indicator states based on the selection indication.

A non-transitory computer-readable medium storing code for wireless communication at a UE is described. The code may include instructions executable by a processor to receive, from a network entity, control signaling identifying two or more transmission configuration indicator states that are to be applied to communications of one or more channels subsequent to a determined time, receive, from the network entity, a periodic communication configuration that provides a series of resource allocations for periodic communications and a selection indication for which of the two or more transmission configuration indicator states are to be selected for the periodic communications, and communicate via the one or more channels according to at least one of the two or more transmission configuration indicator states based on the selection indication.

In some examples of the method, apparatuses, and non-transitory computer-readable medium described herein, the two or more transmission configuration indicator states provide for multi-transmission reception point communications with two or more transmission reception points associated with the network entity. Some examples of the method, apparatuses, and non-transitory computer-readable medium described herein may further include operations, features, means, or instructions for selecting, based on the selection indication, a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point. In some examples of the method, apparatuses, and non-transitory computer-readable medium described herein, the selecting may be further based on a multiplexing scheme or a single frequency network (SFN) scheme indicated by the periodic communication configuration. In some examples of the method, apparatuses, and non-transitory computer-readable medium described herein, the selection indication further indicates a pattern for applying the first transmission configuration indicator state and the second transmission configuration indicator state to different transmission layers, different resource blocks, or different time domain symbols of the multiplexing scheme.

In some examples of the method, apparatuses, and non-transitory computer-readable medium described herein, the communicating may include operations, features, means, or instructions for receiving a downlink transmission according to at least a first transmission configuration indicator state of the two or more transmission configuration indicator states and transmitting an associated uplink transmission responsive to the downlink transmission, where the associated uplink transmission uses a same one or more transmission configuration indicator states as the downlink transmission.

In some examples of the method, apparatuses, and non-transitory computer-readable medium described herein, the communicating may include operations, features, means, or instructions for receiving a downlink transmission according to a first transmission configuration indicator state of the two or more transmission configuration indicator states and transmitting an associated uplink transmission responsive to the downlink transmission, where the periodic communication configuration further indicates that the associated uplink transmission is to use a different transmission configuration indicator state than the downlink transmission.

In some examples of the method, apparatuses, and non-transitory computer-readable medium described herein, the communicating may include operations, features, means, or instructions for receiving two or more downlink transmissions that have different transmission configuration indicator states of the two or more transmission configuration indicator states, selecting one or more transmission configuration indicator states for a first uplink communication that is associated with each of the two or more downlink transmissions based on an index value, a priority of each of the two or more downlink transmissions, or a conflict resolution rule, and transmitting the first uplink communication based on the selecting.

In some examples of the method, apparatuses, and non-transitory computer-readable medium described herein, the selection indication for which of the two or more transmission configuration indicator states is to be selected for periodic uplink control channel communications is provided for each of one or more configured uplink control channel resources. In some examples of the method, apparatuses, and non-transitory computer-readable medium described herein, the selection indication for which of the two or more transmission configuration indicator states is to be selected for periodic uplink control channel communications is based on a semi-persistent scheduling configuration, a channel state information (CSI) report configuration, a scheduling request (SR) resource configuration, or any combinations thereof.

In some examples of the method, apparatuses, and non-transitory computer-readable medium described herein, the selection indication for which of the two or more transmission configuration indicator states is to be selected for periodic uplink control channel communications is based on an indication provided in a medium access control (MAC) control element that activates the periodic uplink control channel communications. In some examples of the method, apparatuses, and non-transitory computer-readable medium described herein, the selection indication for which of the two or more transmission configuration indicator states is to be selected for periodic uplink shared channel communications is based on an indication provided in configuration information for a configured grant that allocates resources for the periodic uplink shared channel communications. In some examples of the method, apparatuses, and non-transitory computer-readable medium described herein, the selection indication for which of the two or more transmission configuration indicator states is to be selected for semi-persistent CSI report on uplink shared channel communications is based on one or more of an indication associated with a CSI reporting configuration or a trigger state associated with the semi-persistent CSI report.

A method for wireless communication at a network entity is described. The method may include transmitting, to a UE, control signaling identifying two or more transmission configuration indicator states that are to be applied to communications of one or more channels subsequent to a determined time, transmitting, to the UE, a periodic communication configuration that provides a series of resource allocations for periodic communications and a selection indication for which of the two or more transmission configuration indicator states are to be selected for the periodic communications, and communicating via the one or more channels according to at least one of the two or more transmission configuration indicator states based on the selection indication.

An apparatus for wireless communication at a network entity is described. The apparatus may include at least one processor; and memory coupled with the at least one processor, the memory storing instructions executable by the at least one processor to cause the apparatus to transmit, to a UE, control signaling identifying two or more transmission configuration indicator states that are to be applied to communications of one or more channels subsequent to a determined time, transmit, to the UE, a periodic communication configuration that provides a series of resource allocations for periodic communications and a selection indication for which of the two or more transmission configuration indicator states are to be selected for the periodic communications, and communicate via the one or more channels according to at least one of the two or more transmission configuration indicator states based on the selection indication.

Another apparatus for wireless communication at a network entity is described. The apparatus may include means for transmitting, to a UE, control signaling identifying two or more transmission configuration indicator states that are to be applied to communications of one or more channels subsequent to a determined time, means for transmitting, to the UE, a periodic communication configuration that provides a series of resource allocations for periodic communications and a selection indication for which of the two or more transmission configuration indicator states are to be selected for the periodic communications, and means for communicating via the one or more channels according to at least one of the two or more transmission configuration indicator states based on the selection indication.

A non-transitory computer-readable medium storing code for wireless communication at a network entity is described. The code may include instructions executable by a processor to transmit, to a UE, control signaling identifying two or more transmission configuration indicator states that are to be applied to communications of one or more channels subsequent to a determined time, transmit, to the UE, a periodic communication configuration that provides a series of resource allocations for periodic communications and a selection indication for which of the two or more transmission configuration indicator states are to be selected for the periodic communications, and communicate via the one or more channels according to at least one of the two or more transmission configuration indicator states based on the selection indication.

In some examples of the method, apparatuses, and non-transitory computer-readable medium described herein, the two or more transmission configuration indicator states provide for multi-transmission reception point communications with two or more transmission reception points associated with the network entity. In some examples of the method, apparatuses, and non-transitory computer-readable medium described herein, the selection indication provides for selection of a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point.

In some examples of the method, apparatuses, and non-transitory computer-readable medium described herein, both the first transmission configuration indicator state and the second transmission configuration indicator state may be selected based on a multiplexing scheme or a single frequency network (SFN) scheme indicated by the periodic communication configuration. In some examples of the method, apparatuses, and non-transitory computer-readable medium described herein, the selection indication further indicates a pattern for applying the first transmission configuration indicator state and the second transmission configuration indicator state to different transmission layers, different resource blocks, or different time domain symbols of the multiplexing scheme.

In some examples of the method, apparatuses, and non-transitory computer-readable medium described herein, the communicating may include operations, features, means, or instructions for transmitting a downlink transmission according to at least a first transmission configuration indicator state of the two or more transmission configuration indicator states and receiving an associated uplink transmission responsive to the downlink transmission, where the associated uplink transmission uses a same one or more transmission configuration indicator states as the downlink transmission.

In some examples of the method, apparatuses, and non-transitory computer-readable medium described herein, the communicating may include operations, features, means, or instructions for transmitting a downlink transmission according to a first transmission configuration indicator state of the two or more transmission configuration indicator states and receiving an associated uplink transmission responsive to the downlink transmission, where the periodic communication configuration further indicates that the associated uplink transmission is to use a different transmission configuration indicator state than the downlink transmission.

In some examples of the method, apparatuses, and non-transitory computer-readable medium described herein, the communicating may include operations, features, means, or instructions for transmitting two or more downlink transmissions that may have different transmission configuration indicator states of the two or more transmission configuration indicator states, selecting one or more transmission configuration indicator states for a first uplink communication that is associated with each of the two or more downlink transmissions based on an index value, a priority of each of the two or more downlink transmissions, or a conflict resolution rule, and receiving the first uplink communication based on the selecting.

In some examples of the method, apparatuses, and non-transitory computer-readable medium described herein, the selection indication for which of the two or more transmission configuration indicator states is to be selected for periodic uplink control channel communications is provided for each of one or more configured uplink control channel resources, is based on a semi-persistent scheduling configuration, a CSI report configuration, a scheduling request (SR) resource configuration, or any combinations thereof.

In some examples of the method, apparatuses, and non-transitory computer-readable medium described herein, the selection indication for which of the two or more transmission configuration indicator states is to be selected for periodic uplink shared channel communications is based on an indication provided in a MAC-CE that activates the periodic uplink control channel communications, or the selection indication for which of the two or more transmission configuration indicator states is to be selected for semi-persistent CSI report on uplink shared channel communications is based on one or more of an indication associated with a CSI reporting configuration or a trigger state associated with the semi-persistent CSI report.

### BRIEF DESCRIPTION OF THE DRAWINGS

FIG. 1 illustrates an example of a wireless communications system that supports transmission configuration state selection for periodic wireless communications with multiple beam indications in accordance with aspects of the present disclosure.

FIG. 2 illustrates an example of a wireless communications system that supports transmission configuration indicator (TCI) state selection for periodic wireless communications with multiple beam indications in accordance with aspects of the present disclosure.

FIG. 3 illustrates an example of multiplexing schemes that supports TCI state selection for periodic wireless communications with multiple beam indications in accordance with aspects of the present disclosure.

FIG. 4 illustrates an example of TCI state timing in accordance with aspects of the present disclosure.

FIG. 5 illustrates an example of TCI states for periodic communications that supports transmission configuration state selection for periodic wireless communications with multiple beam indications in accordance with aspects of the present disclosure.

FIG. 6 illustrates an example of TCI states for periodic communications that supports transmission configuration state selection for periodic wireless communications with multiple beam indications in accordance with aspects of the present disclosure.

FIG. 7 illustrates an example of a process flow that supports transmission configuration state selection for periodic wireless communications with multiple beam indications in accordance with aspects of the present disclosure.

FIGS. 8 and 9 show block diagrams of devices that support transmission configuration state selection for periodic wireless communications with multiple beam indications in accordance with aspects of the present disclosure.

FIG. 10 shows a block diagram of a communications manager that supports transmission configuration state selection for periodic wireless communications with multiple beam indications in accordance with aspects of the present disclosure.

FIG. 11 shows a diagram of a system including a device that supports transmission configuration state selection for periodic wireless communications with multiple beam indications in accordance with aspects of the present disclosure.

FIGS. 12 and 13 show block diagrams of devices that support transmission configuration state selection for periodic wireless communications with multiple beam indications in accordance with aspects of the present disclosure.

FIG. 14 shows a block diagram of a communications manager that supports transmission configuration state selection for periodic wireless communications with multiple beam indications in accordance with aspects of the present disclosure.

FIG. 15 shows a diagram of a system including a device that supports transmission configuration state selection for periodic wireless communications with multiple beam indications in accordance with aspects of the present disclosure.

FIGS. 16 through 24 show flowcharts illustrating methods that support transmission configuration state selection for periodic wireless communications with multiple beam indications in accordance with aspects of the present disclosure.

### DETAILED DESCRIPTION

Implementations described herein provide techniques for indicating a number of activated TCI states, and types of TCI states, using a codepoint that is provided to a user equipment (UE) to select one or more TCI states for periodic communications between the UE and one or more base stations or transmission-reception points (TRPs). In some cases, codepoints may be configured at a UE, and a particular set of available codepoints may be indicated to the UE (e.g., in a medium access control (MAC) control element (CE)). A beam selection indication (e.g., in a beam selection downlink control information (DCI) transmission) may indicate a particular TCI codepoint, and one or more associated TCIs may be used for communications until a subsequent different codepoint is indicated to the UE (e.g., an indication of a TCI codepoint is a “sticky” indication that is used for communications until changed). In some cases, each codepoint may include one or two TCI states, and each respective TCI state identifier in the codepoint may correspond to a TCI state type, such as uplink, downlink, or both. For example, one TCI state or multiple TCI states may be mapped to a single TCI codepoint, where the single TCI codepoint also indicates respective TCI state types for the activated TCI states. In some implementations, the base station (or other network entity) may configure two separate TCI state lists, one for downlink TCI states and one for uplink TCI states. Each codepoint may include one or multiple TCI state identifiers, and an indication of one of the two configured lists with which the TCI state identifier is associated.

A base station or other network entity may adjust or change TCI states used for communications with one or more UEs based on various factors, such as network conditions, traffic loads, numbers of UEs being served, and the like. The changed TCI states may be indicated through changes TCI codepoints. As the TCI codepoints change, the UE may communicate with different combinations of transmission-reception points (TRPs), may use different TCI states, or different combinations of TCI states. However, in cases where periodic communications are scheduled, such as when semi-persistent scheduling (SPS) or configured grant (CG) resources are configured, the SPS/CG periodic communications may span across multiple different TCI codepoints. In such cases, as TCI states change, there can be ambiguity as to which TCI state(s) to use for SPS/CG communications. Various techniques a discussed herein provide for selecting TCI state(s) for periodic (e.g., SPS/CG) communications from multiple configured TCI states.

In accordance with various aspects, described techniques provide for selecting a particular TCI state or TCI states of multiple configured TCI states to be used for periodic communications at a UE. In some cases, periodic communications (e.g., SPS/CG configurations) may be radio resource control (RRC) configured with one of a number of different behaviors when a pair of TCI states are indicated to be applied starting from a given time. A first behavior may be that a first TCI state of the pair of TCI states is applied for periodic communications (e.g., for receiving SPS physical downlink shared channel (PDSCH) transmissions). A second behavior may be that a second TCI state is the pair of TCI states is applied for the periodic communications, and a third behavior may be that both TCI states are applied (e.g., and may be ordered based on a multiplexing scheme). In some cases, periodic downlink transmissions (e.g., SPS PDSCH transmissions) may have an associated uplink transmission (e.g., a physical uplink control channel (PUCCH) that provides acknowledgment/negative-acknowledgement (ACK/NACK) feedback for a PDSCH transmission). In some cases, for periodic uplink control channel transmissions associated with downlink transmissions, a same TCI state as the associated downlink transmission may be used, or a different TCI state may be selected based on a configuration. In some cases, if multiple downlink transmissions (e.g., multiple SPS PDSCHs) are associated with a single uplink transmission (e.g., a PUCCH with ACK/NACK for multiple PDSCHs), the TCI state may be selected based on a rule or configuration (e.g., a conflict resolution rule). For example, a TCI state associated with a lower indexed periodic communication configuration (e.g., two SPS PDSCHs may be configured with each having an associated index value) may be selected, or a TCI state of a higher priority communication may be selected. In some cases, for CG PUCCH transmissions (e.g., channel state information (CSI) or scheduling request (SR) communications) and CG PUSCH, similar alternatives may be used, and configuration information may be used to indicate which TCI state(s) are to be selected for each communication instance.

Particular implementations of the subject matter described in this disclosure can be implemented to realize one or more of the following potential advantages. For example, a single TCI codepoint may be mapped with two TCI states and indicated with TCI state types, and one or more particular TCI states may be selected for a one or more periodic communication instances. By indicating the TCI state types corresponding to the mapped TCI states in a single codepoint, signaling overhead may be reduced. Further, described techniques may support increased flexibility for a UE, because the base station may be able to activate more TCI states of different types (such as, joint or separate TCI states) without a corresponding increase in signaling. This may result in more efficient use of spatial resources, as well as decreased collisions and interference, without introducing signaling delays and increased system latency. Thus, described techniques may result increased reliability of communications and improved user experience. Further, described techniques may support flexible and efficient indications of TCI states supporting mTRP communications, resulting in more efficient and reliable communications and decreased signaling overhead.

Aspects of the disclosure are initially described in the context of wireless communications systems. Aspects of the disclosure are further illustrated by and described with reference to TCI multiplexing schemes, TCI state indications and timing, process flows, apparatus diagrams, system diagrams, and flowcharts that relate to transmission configuration state selection for periodic wireless communications with multiple beam indications.

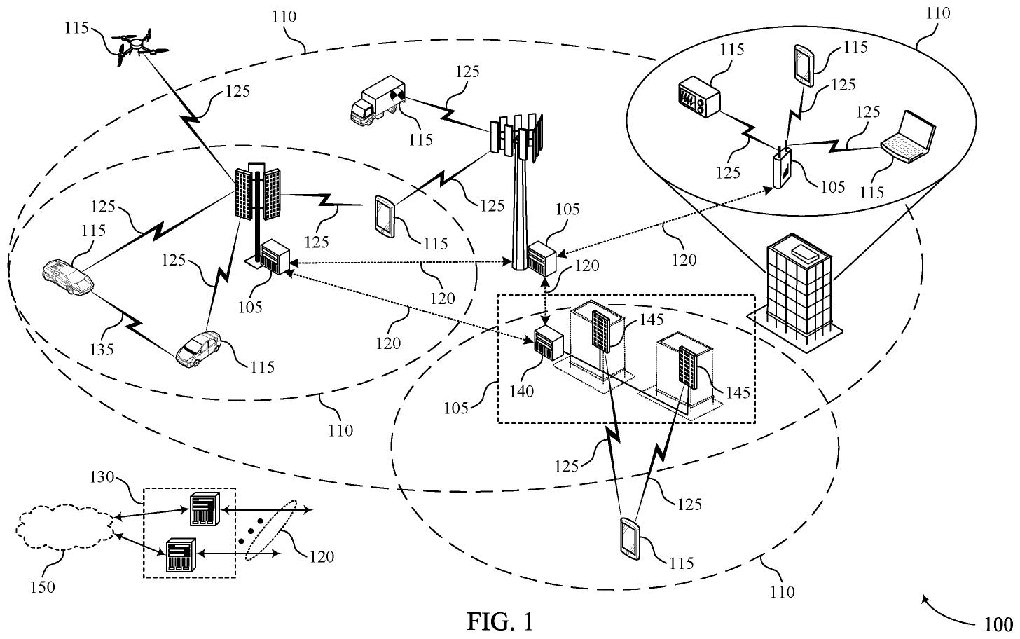

FIG. 1 illustrates an example of a wireless communications system 100 that supports transmission configuration state selection for periodic wireless communications with multiple beam indications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or an MTC device, or the like, which may be implemented in various articles such as appliances, drones, robots, vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In accordance with various aspects, techniques are described for configuration of multiple TCI states and selection of a particular TCI state or TCI states for different instances of scheduled periodic communications between a UE 115 and one or more TRPs or base stations 105. In some cases, a UE 115 may receive, from a network entity (e.g., a base station 105 or TRP), control signaling identifying two or more TCI states that are to be applied to communications of one or more channels subsequent to a determined time. The network entity may also provide a periodic communication configuration with a series of resource allocations for periodic communications, and a selection indication for which of the two or more TCI states are to be selected for the periodic communications. The UE 115 may communicate (e.g., with a base station 105 via one or more TRPs) via the one or more channels according to at least one of the two or more TCI states based at least in part on the selection indication.

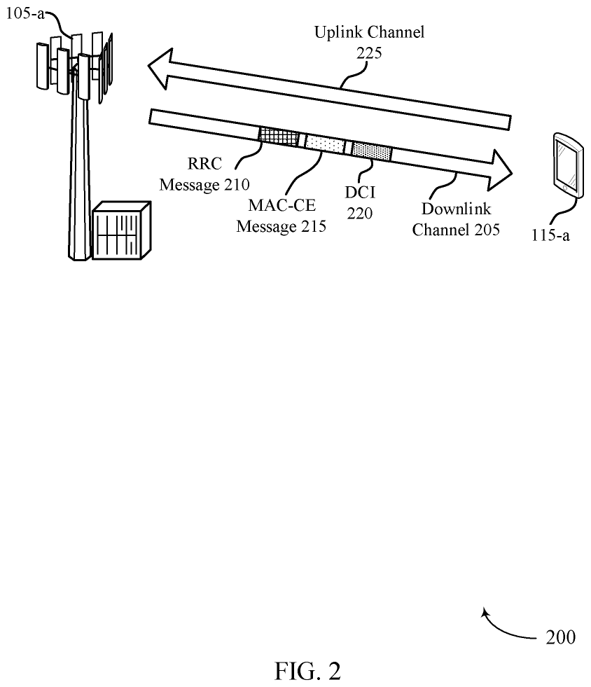

FIG. 2 illustrates an example of a wireless communications system 200 that supports transmission configuration state selection for periodic wireless communications with multiple beam indications in accordance with aspects of the present disclosure. The wireless communications system 200 may be an example of the wireless communications system 100. For example, the wireless communications system 200 may include a UE 115-a and a base station 105-a, which may be examples of the UE 115 and the base station 105 as described with reference to FIG. 1. While examples are discussed herein, any number of devices and device types may be used to accomplish implementations described in the present disclosure. As used herein, the term beam configuration may be referred to as a TCI state, and the term TCI state may be referred to as a beam configuration.

The base station 105-a and the UE 115-a may communicate via a downlink channel 205 and an uplink channel 225. In some wireless communications systems, such as 5G or NR, different types of TCI states may be used to improve channel utilization between wireless devices. For example, a wireless communications system may support joint TCI states for both downlink and uplink signaling using a unified TCI framework. In some systems, wireless communications systems may support a single TCI codepoint that is mapped to multiple TCI states, such as one downlink TCI state and one uplink TCI state. However, as discussed herein, such techniques may not clearly indicate the TCI state type of a pair of TCI states, such as joint downlink and uplink TCI states, separate uplink or downlink TCI states, common uplink or downlink TCI states, for some communications such as periodic communications (e.g., SPS or CG communications) that are scheduled between the UE 115-a and base station 105-a.

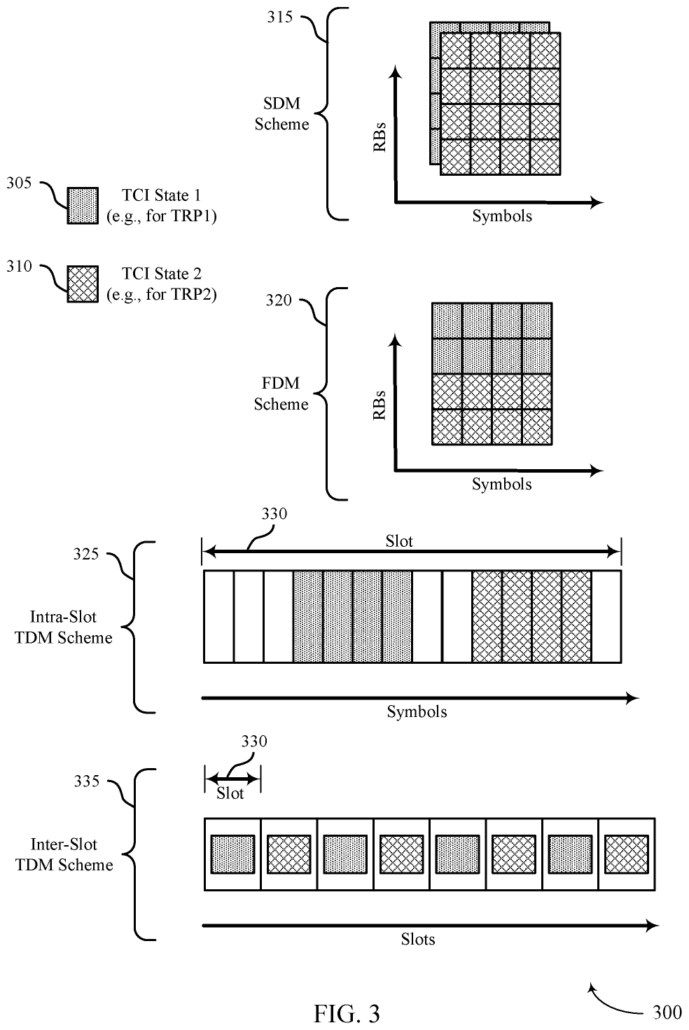

In some implementations, the UE 115-a may receive a configuration of TCI states from the base station 105-a, such as in a RRC message 210 via RRC signaling. The UE 115-a may receive a MAC-CE message 215 from the base station 105-a associated with the configuration of TCI states, where the MAC-CE message 215 may activate a subset of configured TCI states along with a mapping to TCI codepoints. In accordance with various aspects discussed herein, control information such as DCI 220 (e.g., a beam selection DCI) may indicate a particular TCI state codepoint, for use in communications with the base station 105-a, where the TCI codepoint indicates a particular TCI state or two or more particular TCI states from the subset of activated TCI states. In some cases, periodic communications may be configured to provide a selection of one or more TCI state(s) for instances of the periodic communications based at least in part on TCI states that are indicated in a TCI codepoint. Various examples of TCI states, TCI state multiplexing, and signaling for one or more TCI states that are to be applied for certain communications, are discussed with reference to FIGS. 3 through 7.

FIG. 3 illustrates an example of multiplexing schemes 300 that support transmission configuration state selection for periodic wireless communications with multiple beam indications in accordance with aspects of the present disclosure. The multiplexing schemes 300 may implement or be implemented by one or more aspects of the wireless communications systems 100 or 200. For example, the multiplexing schemes 300 may be utilized by one or more TRPs (e.g., base stations or TRPs associated with a base station), and a UE, which may be examples of corresponding devices as described with reference to FIGS. 1 and 2.

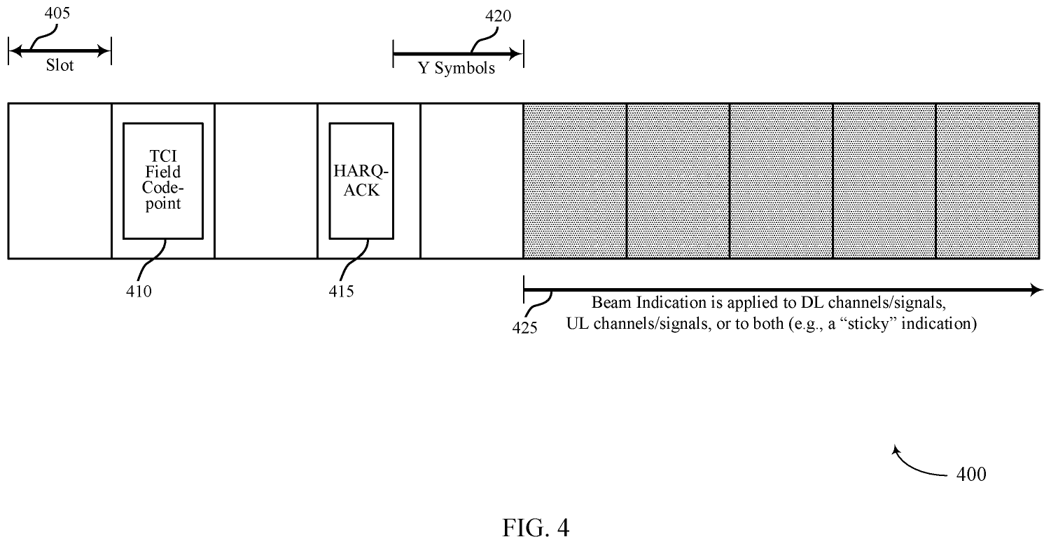

In the example of FIG. 3, a first TCI state 305 and a second TCI state 310 are illustrated. In some cases, the first TCI state 305 and the second TCI state 310 may be associated with a TCI codepoint that is provided to a UE (e.g., in a MAC-CE) and selected with a beam selection DCI, for use in subsequent communications with one or more TRPs. In some cases, one or more multiplexing schemes may be used. For example, a spatial division multiplexing (SDM) scheme 315 may be implemented, in which different spatial layers are associated with different TCI states. In some cases, a frequency division multiplexing (FDM) scheme 320 may be implemented, in which different frequency resources are associated with different TCI states. In other cases, time division multiplexing (TDM) may be implemented, such as an intra-slot TDM scheme 325 or an inter-slot TDM scheme 335 may have different time resources within a slot 330 or across slots 330 that are associated with different TCI states. As discussed herein, a MAC-CE may indicate TCI states based on a mapping between the one or two TCI states to TCI codepoints, and a beam selection DCI may activate one of the TCI codepoints. In some cases, for periodic communications, a configuration of the periodic communications (e.g., a SPS or CG configuration) may provide an indication of one or two of the activated TCI states that are to be used for particular communication instance. If the indicated TCI codepoint is mapped to two TCI states, a communication with two TCI states (e.g., according to one of the multiplexing schemes of FIG. 3) is scheduled. An example of an activation DCI and TCI state application timing is discussed with reference to FIG. 4.

FIG. 4 illustrates an example of TCI state timing 400 in accordance with aspects of the present disclosure. The TCI state timing 400 may be implemented by one or more aspects of the wireless communications systems 100 or 200. For example, the TCI state timing 400 may be utilized by one or more TRPs (e.g., base stations or TRPs associated with a base station), and a UE, which may be examples of corresponding devices as described with reference to FIGS. 1 and 2.

In the example of FIG. 4, a UE and TRP may communicate in slots 405, in which one of the slots 405 may include a beam selection DCI that indicates a TCI field codepoint 410 (e.g., from two or more mapped TCI codepoints provided by a MAC-CE). As discussed herein, the TCI field codepoint 410 may be mapped to one or multiple TCI states (e.g., one or more uplink TCI states, one or more downlink TCI states, one or more joint DL/UL TCI states, or any combinations thereof). For example, one TCI field codepoint 410 may represent one or more joint downlink/uplink TCI states, which may be used for joint downlink/uplink beam indication. In another example, one TCI field codepoint 410 may represent one or more pairs with a downlink TCI state and uplink TCI state, which may be used for separate downlink/uplink beam indications. In other examples, one TCI field codepoint 410 may represent only one or more downlink TCI states, which may be used for downlink beam indication, or one TCI field codepoint 410 may represent only one or more uplink TCI states, which may be used for uplink beam indication. In some cases, if the MAC-CE indicates the mapping to only a single TCI field codepoint, it may serve as a beam indication, and a separate beam indication in a beam selection DCI may not be needed.

A UE that receives the DCI with the TCI field codepoint 410 may transmit a feedback indication, such as a HARQ-acknowledgment 415, to a base station or TRP that indicates successful receipt of the DCI. In some cases, the beam indication provided in the TCI field codepoint 410 may be applied to communications starting a predetermined time period 420 (e.g., Y symbols) after the HARQ-acknowledgment 415 (e.g., which may be an example of a determined time at which to apply the TCI state(s)). For example, the beam indication may be applied three milliseconds after HARQ-acknowledgment 415, as indicated at 425 in the example of FIG. 4. In some cases, the predetermined time period 420 may be applied in the first slot that is at least Y symbols (e.g., which is RRC-configured based on UE capability) after the last symbol of a control channel transmission (e.g., a physical uplink control channel (PUCCH) transmission) carrying the HARQ-acknowledgment 415. In some cases, the beam indication may be a “sticky” indications in that it is not related to the scheduled shared channel communication (e.g., a physical downlink shared channel (PDSCH) transmission), and it is not a one-time indication. When the beam indication is applied, it remains the same for the applicable channels/signals until changed (e.g., another MAC-CE or DCI format 1_1/1_2 changes the beam). In some cases, the beam indication may be common for multiple downlink channels/signals (e.g., PDSCH, PDCCH, CSI-RS) and/or multiple uplink channels/signals (PUSCH, PUCCH, SRS).

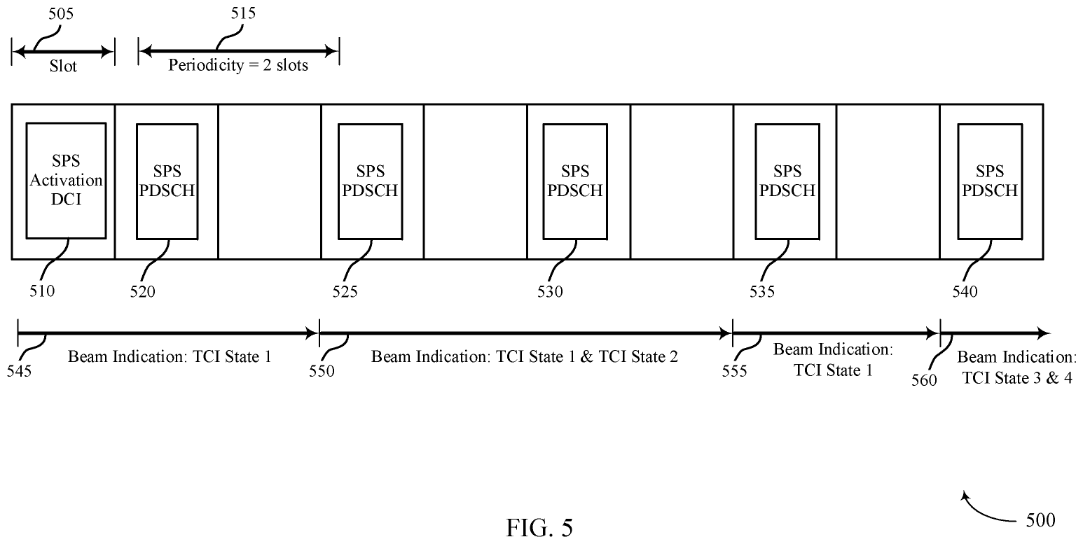

As discussed herein, in some cases, when two TCI states are applied to PDSCH/PUSCH/PUCCH transmissions starting after predetermined time period 420 (e.g., the first slot that is at least Y symbols after the last symbol of HARQ-acknowledgment 415), it may be desirable for a serving base station to schedule single-TRP (sTRP) operation with one TCI state among the two applied TCI states for periodic communications. In some cases, a periodic communication may be configured such that one or more TCI states of a pair of configured TCI states is selected for an associated communication, examples of which are discussed with reference to FIGS. 5 through 7.

FIG. 5 illustrates an example of TCI states for periodic communications 500 with multiple beam indications in accordance with aspects of the present disclosure. The TCI states for periodic communications 500 may be implemented by one or more aspects of the wireless communications systems 100 or 200. For example, the TCI states may be utilized by one or more TRPs (e.g., base stations or TRPs associated with a base station), and a UE, which may be examples of corresponding devices as described with reference to FIGS. 1 and 2.

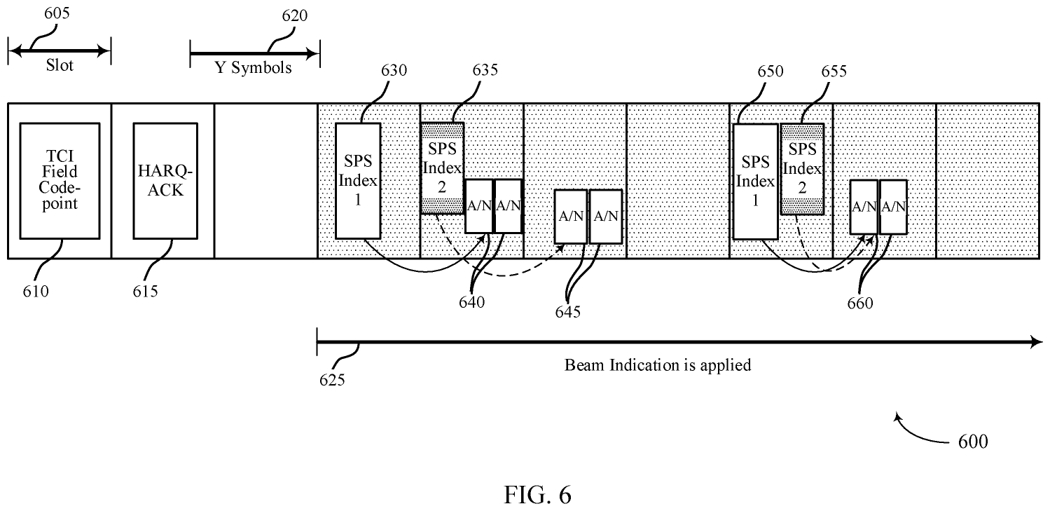

In the example of FIG. 5, a base station or other network entity may transmit, and a UE may receive, a periodic communications configuration (e.g. a SPS or CG configuration), which may provide a selection indication for selecting a TCI states of a pair of TCI states for communications in slots 505 between the UE and base station. The periodic communications may be activated by a SPS activation DCI 510, which may activate SPS PDSCH transmissions with a periodicity 515 of two slots, resulting in SPS PDSCHs 520 through 540 being transmitted in with a periodicity of two slots. In this example, activated TCI codepoints for communications between the UE and TRP(s) may change on a number of occasions. For example, a first SPS PDSCH 520 may be transmitted when a TCI codepoint indicates a first beam indication 545 (e.g., with TCI state 1), a second SPS PDSCH 525 and third SPS PDSCH 530 may be transmitted when a TCI codepoint indicates a second beam indication 550 (e.g., with TCI states 1 and 2), a fourth SPS PDSCH 535 may be transmitted when a TCI codepoint indicates a third beam indication 555 (e.g., with TCI state 1), and a fifth SPS PDSCH 540 may be transmitted when a TCI codepoint indicates a fourth beam indication 560 (e.g., with TCI states 3 and 4). In accordance with techniques discussed herein, the particular TCI state used for each SPS PDSCH 520 through 540 may be selected based on configuration information provided in the periodic communications configuration. Some examples of TCI state selection based on periodic communication configuration information are discussed with reference to FIG. 6.

FIG. 6 illustrates an example of TCI states for periodic communications 600 that support transmission configuration state selection for periodic wireless communications with multiple beam indications in accordance with aspects of the present disclosure. The TCI states for periodic communications 600 may be implemented by one or more aspects of the wireless communications systems 100 or 200. For example, the TCI states may be utilized by one or more TRPs (e.g., base stations or TRPs associated with a base station), and a UE, which may be examples of corresponding devices as described with reference to FIGS. 1 and 2.

In the example of FIG. 6, a base station or other network entity may transmit, and a UE may receive, a DCI with a TCI field codepoint 610, which may indicate a pair of TCI states for communications in slots 605 between the UE and base station. Similarly as discussed with reference to FIG. 4, the UE may transmit a HARQ-acknowledgment 615, and may apply the beam indication at 625, following predetermined time period 620 (e.g., Y symbols) after transmission of the HARQ-acknowledgment 615. In this example, when a pair of TCI states (e.g., DL/UL/both/joint) are indicated to be applied following the predetermined time period 620, one or more TCI states may be selected for periodic communications based on a configured behavior for the associated periodic communications.

In the example of FIG. 6, a UE may be configured with two different SPS configurations. A first SPS configuration may have an SPS index value of one, with a periodicity of four slots, and a second SPS configuration may have an SPS index value of two, with a periodicity of three slots. In some cases, each SPS configuration may be RRC configured with one of the following behaviors when a pair of TCI states (DL or joint) are indicated to be applied starting from a given time, and if the SPS configuration is active (e.g., previously activated by an activation DCI). A first behavior may be that a first TCI state of the pair of TCI states is applied for the SPS PDSCHs. A second behavior may be that a second TCI state of the pair of TCI states is applied for the SPS PDSCHs. A third behavior may be that both TCI states are applied for the SPS PDSCHs. In such cases, how the two TCI states are applied may depend on a SDM/TDM/FDM/SFN scheme, which may be based on RRC configuration and the activation DCI. Further, in some cases the order of applying the two TCI states may be RRC configured (e.g., for SDM/FDM/TDM schemes, whether the first TCI state is applied to the first or second sets of layers/RBs/symbols).

Additionally, tor periodic HARQ ACK/NACK transmissions on PUCCH associated with the SPS PDSCHs, and when a pair of TCI states (e.g., UL or joint TCI states) are indicated to be applied starting from a given time, a same behavior as SPS PDSCH may be followed for HARQ ACK/NACK on PUCCH, or a different RRC configuration per SPS configuration may indicate one of the described behaviors specific to HARQ ACK/NACK transmission. For example, in FIG. 6, the first SPS configuration with index=1 may be configured with the third behavior for SPS PDSCHs and the first behavior for transmissions of associated HARQ ACK/NACK on PUCCH, while the second SPS configuration with index=2 may be configured with the first behavior for both SPS PDSCHs and HARQ ACK/NACK on PUCCHs. Thus, a first instance of a SPS PDSCH 630 of the first SPS configuration may have an associated ACK/NACK 640, which includes two repetitions of the ACK/NACK transmission on PUCCH according to the first SPS configuration. Further, a first instance of SPS PDSCH 635 of the second SPS configuration may have an associated ACK/NACK 645, which includes two repetitions of the ACK/NACK transmission on PUCCH according to the second SPS configuration.

In this example, based on the periodicities of the SPS configurations, a second instance of SPS PDSCH 650 of the first SPS configuration and a second instance of SPS PDSCH 655 of the second SPS configuration are both transmitted in a same slot, such that a HARQ ACK/NACK 660 of both PDSCH instances are transmitted on the same PUCCH resource. In this example, the different SPS configurations are RRC configured with different behaviors. In such cases, a UE may follow one or more rules for selecting the associated TCI state for transmission of ACK/NACK 660. In some cases, the UE may follow the behavior associated with the SPS configuration with the lower SPS index value (e.g., follow the first SPS configuration). In other cases, each behavior may have a different priority and the UE may follow the behavior with a higher priority (e.g., behavior 3 has higher priority than behavior 1, and in the case of conflict behavior 3 is followed). In other cases, a priority of the communication of the associated SPS PDSCH may be followed.

While the illustration of FIG. 6 shows SPS PDSCH communications, such techniques and behaviors may be configured for uplink periodic communications as well. For example, for periodic PUCCH transmissions, in the case that a pair of TCI states (e.g., UL or joint) are indicated to be applied starting from a given time, one of the behaviors discussed above may be configured per PUCCH resource. In some cases, the PUCCH resource, and hence the behavior, may be indicated by DCI (e.g., for dynamic HARQ-ACK/NACK) or by RRC (e.g., for periodic PUCCH). In other cases, one of the behaviors discussed above may be RRC configured, where this RRC configuration is per SPS-configuration (e.g., for SPS HARQ-ACK/NACK), per CSI report setting (e.g., per CSI-ReportConfig) for periodic or semi-persistent CSI (SP-CSI) on PUCCH, per SR resource configuration (e.g., per SchedulingRequestResourceConfig) for SR on PUCCH. In further cases, one of the behaviors discussed above may be indicated by the MAC-CE that activates the periodic communications (e.g., that activates SP-CSI reporting on PUCCH). In some cases, one or more bits in a MAC-CE can be used for to indicate the behavior that a UE is to follow.

For periodic physical uplink shared channel (PUSCH) communications, such techniques may also be used. For example, in the case that a pair of TCI states (e.g., UL or joint) are indicated to be applied starting from a given time, for CG-PUSCH (e.g., either Type 1 or Type 2 CG) one of the described behaviors can be RRC configured per CG configuration (e.g., per ConfiguredGrantConfig). Similarly as discussed for SPS configurations, this makes it possible to configure different CGs with different behaviors (e.g., CG configuration with index=1 with the third behavior and CG configuration with index=2 with the first behavior). In some cases, for SP-CSI on PUSCH (e.g., DCI activates SP-CSI on PUSCH, and the transmissions occur periodically until another DCI deactivates the SP-CSI), one of the described behaviors may be RRC configured, where this RRC configuration may be provided per CSI report setting (e.g., per CSI-ReportConfig), or per CSI trigger state (e.g., per CSI-SemiPersistentOnPUSCH-TriggerState).

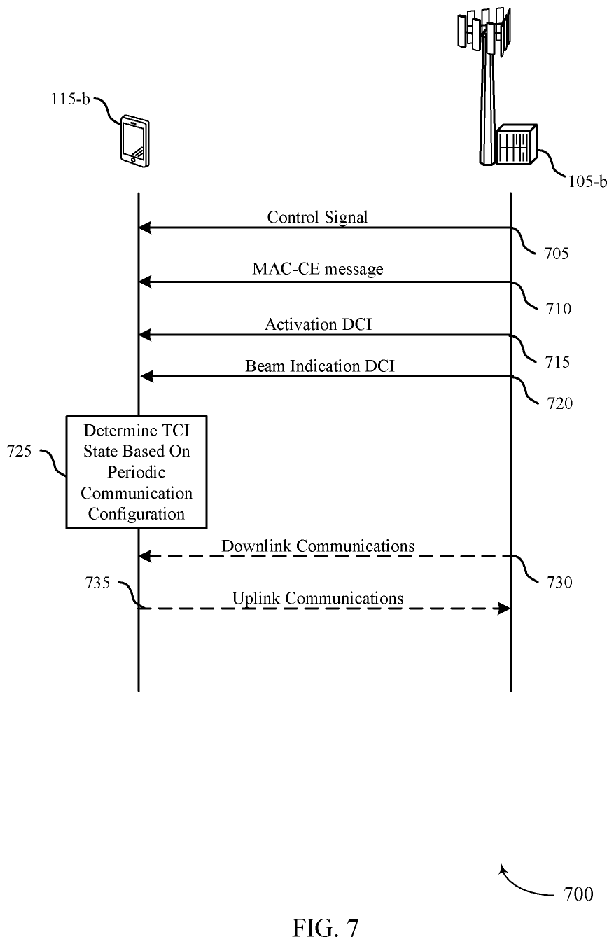

FIG. 7 illustrates an example of a process flow 700 that supports transmission configuration state selection for periodic wireless communications with multiple beam indications in accordance with aspects of the present disclosure. The process flow may be implemented by devices in a wireless communications system as discussed herein. For example, the process flow 700 may include a UE 115-b and a base station 105-b, which may be examples of UEs 115 and base stations 105 as discussed with reference to FIGS. 1 and 2. In the following description of the process flow 700, operations between the UE 115-b and the base station 105-b, may occur in a different order or at different times than as shown. Some operations also may be omitted from the process flow 700, and other operations may be added to the process flow 700, such as multiple TRPs in addition to the base station 105-b.

At 705, the base station 105-b may transmit a control signal to the UE 115-b. For example, the base station 105-b may transmit an RRC message to the UE 115-b indicating a set of available beam configurations TCI states, or multiple lists of beam configurations. In some implementations, beam configurations may refer to TCI states. Beam configurations may refer to one or more configurations or settings for transmitting uplink signaling, receiving downlink signaling, or both, such as TCI states. In some cases, the control signal may also provide one or more periodic communication configurations (e.g., an SPS or CG configuration). At 710, the base station 105-b may transmit a MAC-CE message to the UE 115-b indicating which TCI states, as indicated by the control signal (e.g., RRC message) at 705, are activated. In some implementations, the MAC-CE message may indicate joint TCI states, single TCI states, or both.

At 715, the base station 105-b may transmit an activation DCI to the UE 115-b, which may activate one or more configured periodic communications (e.g., one or more SPS or CG configurations). At 720, the base station 105-b may transmit a beam indication DCI to the UE 115-b. In some cases, the beam indication DCI may indicate which TCI state(s) (e.g., in a TCI field codepoint) are associated with one or more communications instances the UE 115-b may utilize to communicate with the base station 105-b, such as discussed with reference to the examples of FIGS. 2 through 6.

At 725, the UE 115-b may determine one or more TCI state(s) for communications based on the periodic communication configuration, such as discussed with reference to the examples of FIGS. 5 and 6. In such implementations, the UE 115-b may utilize an uplink TCI state and a downlink TCI state to perform uplink and downlink communications with the base station 105-b. In some implementations, the DCI may activate an uplink TCI state for uplink communications, or a downlink TCI state for downlink communications, or both. Optionally, at 730, associated with the determination of the TCI state, the UE 115-b may perform periodic downlink communications with the base station 105-b. Optionally, at 735, associated with the determination of the TCI state, the UE 115-b may perform periodic uplink communications with the base station 105-b. In cases where the TCI state indicates two TCI states for uplink or downlink (or both), the communications may be mTRP communications in accordance with a multiplexing scheme, as discussed herein.

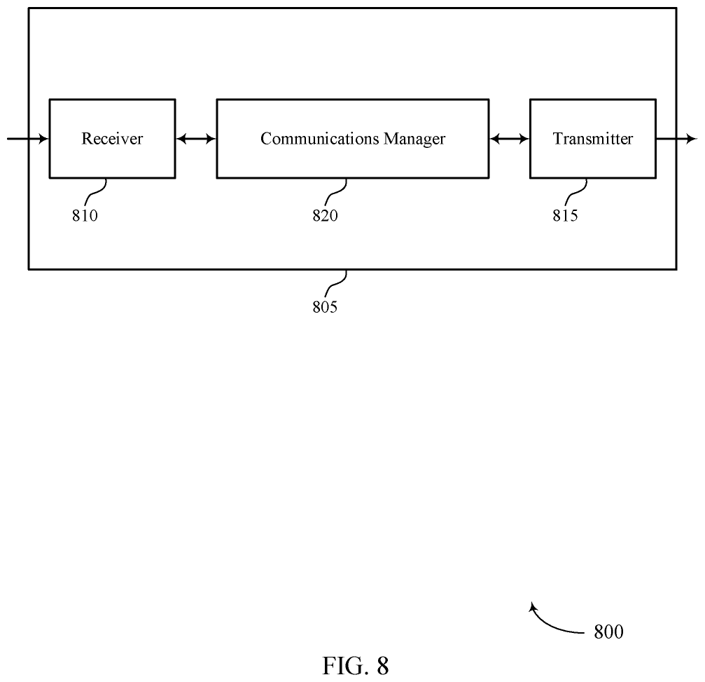

FIG. 8 shows a block diagram 800 of a device 805 that supports transmission configuration state selection for periodic wireless communications with multiple beam indications in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to transmission configuration state selection for periodic wireless communications with multiple beam indications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to transmission configuration state selection for periodic wireless communications with multiple beam indications). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of transmission configuration state selection for periodic wireless communications with multiple beam indications as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software) executed by a processor. If implemented in code executed by a processor, the functions of the communications manager 820, the receiver 810, the transmitter 815, or various combinations or components thereof may be performed by a general-purpose processor, a DSP, a central processing unit (CPU), a graphics processing unit (GPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communication at a UE in accordance with examples as disclosed herein. For example, the communications manager 820 may be configured as or otherwise support a means for receiving, from a network entity, control signaling identifying two or more transmission configuration indicator states that are to be applied to communications of one or more channels subsequent to a determined time. The communications manager 820 may be configured as or otherwise support a means for receiving, from the network entity, a periodic communication configuration that provides a series of resource allocations for periodic communications and a selection indication for which of the two or more transmission configuration indicator states are to be selected for the periodic communications. The communications manager 820 may be configured as or otherwise support a means for communicating via the one or more channels according to at least one of the two or more transmission configuration indicator states based on the selection indication.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for selection of one or more particular TCI states for a one or more periodic communications where multiple TCI states are configured, which may provide for reduced signaling overhead, increased flexibility, more efficient use of spatial resources, decreased collisions and interference, increased reliability of communications, and improved user experience.

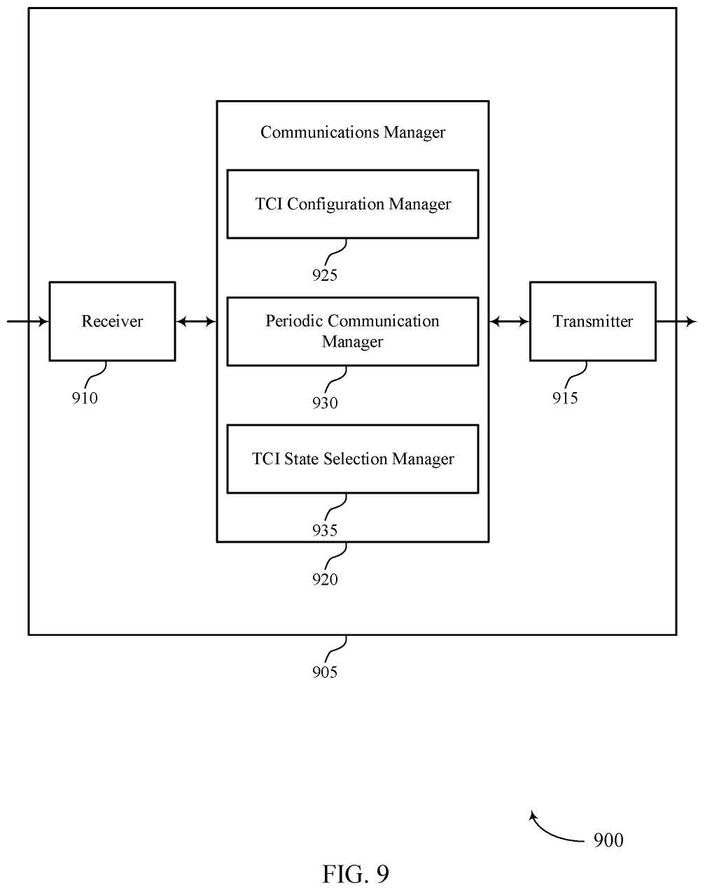

FIG. 9 shows a block diagram 900 of a device 905 that supports transmission configuration state selection for periodic wireless communications with multiple beam indications in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to transmission configuration state selection for periodic wireless communications with multiple beam indications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to transmission configuration state selection for periodic wireless communications with multiple beam indications). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of transmission configuration state selection for periodic wireless communications with multiple beam indications as described herein. For example, the communications manager 920 may include a TCI configuration manager 925, a periodic communication manager 930, a TCI state selection manager 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a UE in accordance with examples as disclosed herein. The TCI configuration manager 925 may be configured as or otherwise support a means for receiving, from a network entity, control signaling identifying two or more transmission configuration indicator states that are to be applied to communications of one or more channels subsequent to a determined time. The periodic communication manager 930 may be configured as or otherwise support a means for receiving, from the network entity, a periodic communication configuration that provides a series of resource allocations for periodic communications and a selection indication for which of the two or more transmission configuration indicator states are to be selected for the periodic communications. The TCI state selection manager 935 may be configured as or otherwise support a means for communicating via the one or more channels according to at least one of the two or more transmission configuration indicator states based on the selection indication.

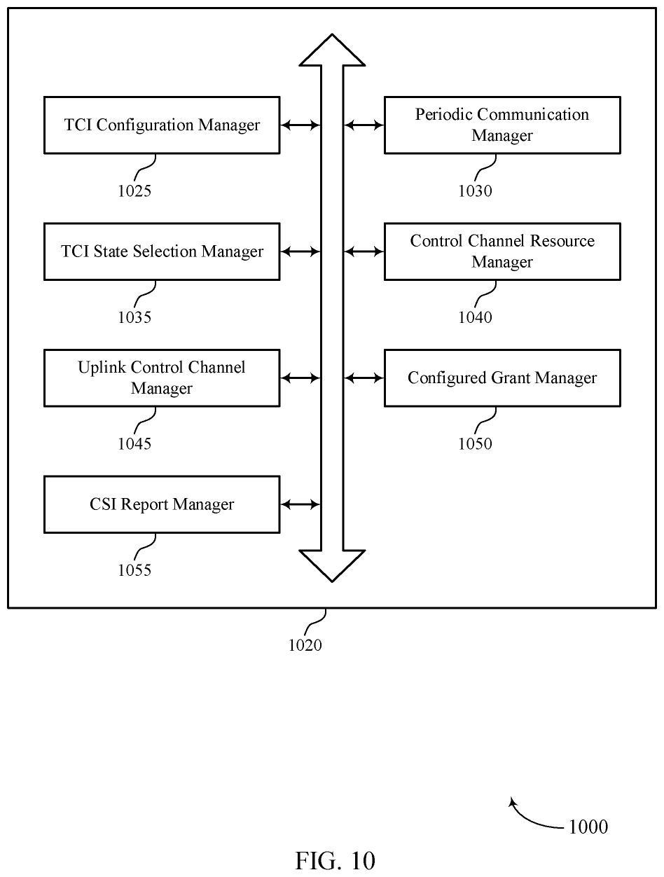

FIG. 10 shows a block diagram 1000 of a communications manager 1020 that supports transmission configuration state selection for periodic wireless communications with multiple beam indications in accordance with aspects of the present disclosure. The communications manager 1020 may be an example of aspects of a communications manager 820, a communications manager 920, or both, as described herein. The communications manager 1020, or various components thereof, may be an example of means for performing various aspects of transmission configuration state selection for periodic wireless communications with multiple beam indications as described herein. For example, the communications manager 1020 may include a TCI configuration manager 1025, a periodic communication manager 1030, a TCI state selection manager 1035, a control channel resource manager 1040, an uplink control channel manager 1045, a configured grant manager 1050, a CSI report manager 1055, or any combination thereof. Each of these components may communicate, directly or indirectly, with one another (e.g., via one or more buses).

The communications manager 1020 may support wireless communication at a UE in accordance with examples as disclosed herein. The TCI configuration manager 1025 may be configured as or otherwise support a means for receiving, from a network entity, control signaling identifying two or more transmission configuration indicator states that are to be applied to communications of one or more channels subsequent to a determined time. The periodic communication manager 1030 may be configured as or otherwise support a means for receiving, from the network entity, a periodic communication configuration that provides a series of resource allocations for periodic communications and a selection indication for which of the two or more transmission configuration indicator states are to be selected for the periodic communications. The TCI state selection manager 1035 may be configured as or otherwise support a means for communicating via the one or more channels according to at least one of the two or more transmission configuration indicator states based on the selection indication. In some examples, the two or more transmission configuration indicator states provide for multi-transmission reception point communications with two or more transmission reception points associated with the network entity.

In some examples, the TCI state selection manager 1035 may be configured as or otherwise support a means for selecting, based on the selection indication, a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point. In some examples, the selecting is further based on a multiplexing scheme or a single frequency network (SFN) scheme indicated by the periodic communication configuration. In some examples, the selection indication further indicates a pattern for applying the first transmission configuration indicator state and the second transmission configuration indicator state to different transmission layers, different resource blocks, or different time domain symbols of the multiplexing scheme.

In some examples, to support communicating, the periodic communication manager 1030 may be configured as or otherwise support a means for receiving a downlink transmission according to at least a first transmission configuration indicator state of the two or more transmission configuration indicator states. In some examples, to support communicating, the periodic communication manager 1030 may be configured as or otherwise support a means for transmitting an associated uplink transmission responsive to the downlink transmission, where the associated uplink transmission uses a same one or more transmission configuration indicator states as the downlink transmission.

In some examples, to support communicating, the periodic communication manager 1030 may be configured as or otherwise support a means for receiving a downlink transmission according to a first transmission configuration indicator state of the two or more transmission configuration indicator states. In some examples, to support communicating, the periodic communication manager 1030 may be configured as or otherwise support a means for transmitting an associated uplink transmission responsive to the downlink transmission, where the periodic communication configuration further indicates that the associated uplink transmission is to use a different transmission configuration indicator state than the downlink transmission.

In some examples, to support communicating, the periodic communication manager 1030 may be configured as or otherwise support a means for receiving two or more downlink transmissions that have different transmission configuration indicator states of the two or more transmission configuration indicator states. In some examples, to support communicating, the TCI state selection manager 1035 may be configured as or otherwise support a means for selecting one or more transmission configuration indicator states for a first uplink communication that is associated with each of the two or more downlink transmissions based on an index value, a priority of each of the two or more downlink transmissions, or a conflict resolution rule. In some examples, to support communicating, the periodic communication manager 1030 may be configured as or otherwise support a means for transmitting the first uplink communication based on the selecting.

In some examples, the selection indication for which of the two or more transmission configuration indicator states are to be selected for periodic uplink control channel communications is provided for each of one or more configured uplink control channel resources. In some examples, the selection indication for which of the two or more transmission configuration indicator states are to be selected for periodic uplink control channel communications is based on a semi-persistent scheduling configuration, a CSI report configuration, a scheduling request (SR) resource configuration, or any combinations thereof. In some examples, the selection indication for which of the two or more transmission configuration indicator states are to be selected for periodic uplink control channel communications is based on an indication provided in a medium access control (MAC) control element that activates the periodic uplink control channel communications.

In some examples, the selection indication for which of the two or more transmission configuration indicator states are to be selected for periodic uplink shared channel communications is based on an indication provided in configuration information for a configured grant that allocates resources for the periodic uplink shared channel communications. In some examples, the selection indication for which of the two or more transmission configuration indicator states are to be selected for semi-persistent CSI report on uplink shared channel communications is based on one or more of an indication associated with a CSI reporting configuration or a trigger state associated with the semi-persistent CSI report.

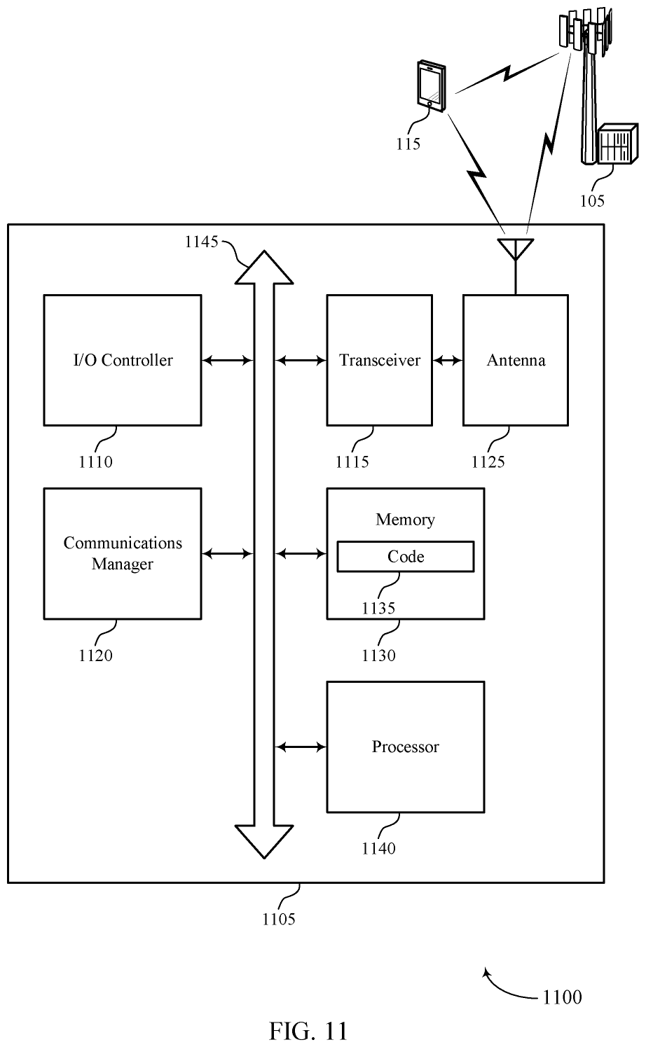

FIG. 11 shows a diagram of a system 1100 including a device 1105 that supports transmission configuration state selection for periodic wireless communications with multiple beam indications in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting transmission configuration state selection for periodic wireless communications with multiple beam indications). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 may be configured as or otherwise support a means for receiving, from a network entity, control signaling identifying two or more transmission configuration indicator states that are to be applied to communications of one or more channels subsequent to a determined time. The communications manager 1120 may be configured as or otherwise support a means for receiving, from the network entity, a periodic communication configuration that provides a series of resource allocations for periodic communications and a selection indication for which of the two or more transmission configuration indicator states are to be selected for the periodic communications. The communications manager 1120 may be configured as or otherwise support a means for communicating via the one or more channels according to at least one of the two or more transmission configuration indicator states based on the selection indication.

By including or configuring the communications manager 1120 in accordance with examples as described herein, the device 1105 may support techniques for selection of one or more particular TCI states for a one or more periodic communications where multiple TCI states are configured, which may provide for reduced signaling overhead, increased flexibility, more efficient use of spatial resources, decreased collisions and interference, increased reliability of communications, and improved user experience.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of transmission configuration state selection for periodic wireless communications with multiple beam indications as described herein, or the processor 1140 and the memory 1130 may be otherwise configured to perform or support such operations.

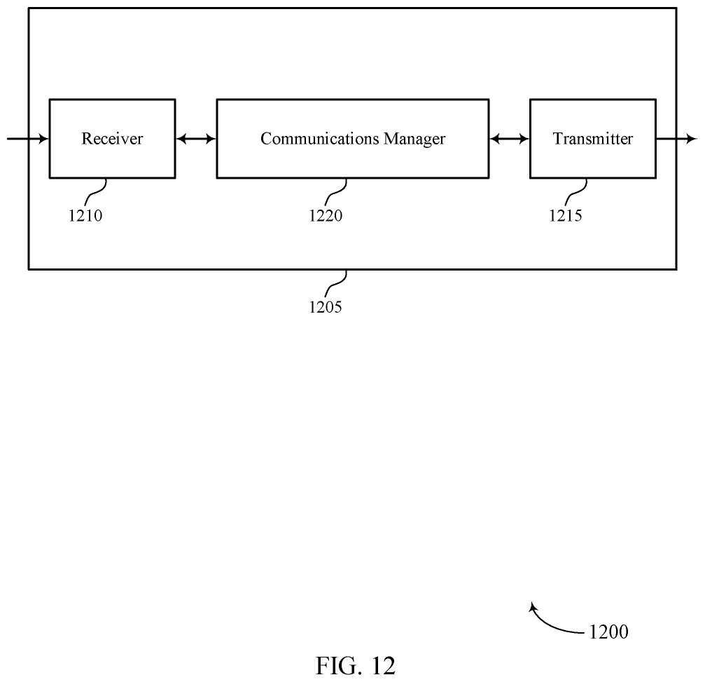

FIG. 12 shows a block diagram 1200 of a device 1205 that supports transmission configuration state selection for periodic wireless communications with multiple beam indications in accordance with aspects of the present disclosure. The device 1205 may be an example of aspects of a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to transmission configuration state selection for periodic wireless communications with multiple beam indications). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to transmission configuration state selection for periodic wireless communications with multiple beam indications). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of transmission configuration state selection for periodic wireless communications with multiple beam indications as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software) executed by a processor. If implemented in code executed by a processor, the functions of the communications manager 1220, the receiver 1210, the transmitter 1215, or various combinations or components thereof may be performed by a general-purpose processor, a DSP, a CPU, a GPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communication at a network entity in accordance with examples as disclosed herein. For example, the communications manager 1220 may be configured as or otherwise support a means for transmitting, to a UE, control signaling identifying two or more transmission configuration indicator states that are to be applied to communications of one or more channels subsequent to a determined time. The communications manager 1220 may be configured as or otherwise support a means for transmitting, to the UE, a periodic communication configuration that provides a series of resource allocations for periodic communications and a selection indication for which of the two or more transmission configuration indicator states are to be selected for the periodic communications. The communications manager 1220 may be configured as or otherwise support a means for communicating via the one or more channels according to at least one of the two or more transmission configuration indicator states based on the selection indication.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for selection of one or more particular TCI states for a one or more periodic communications where multiple TCI states are configured, which may provide for reduced signaling overhead, increased flexibility, more efficient use of spatial resources, decreased collisions and interference, increased reliability of communications, and improved user experience.

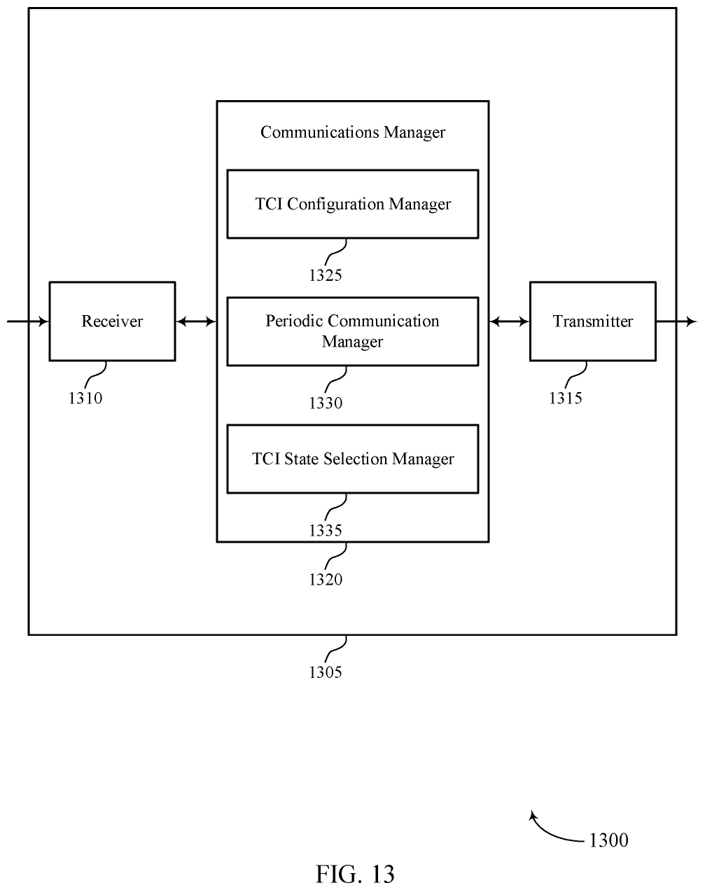

FIG. 13 shows a block diagram 1300 of a device 1305 that supports transmission configuration state selection for periodic wireless communications with multiple beam indications in accordance with aspects of the present disclosure. The device 1305 may be an example of aspects of a device 1205 or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to transmission configuration state selection for periodic wireless communications with multiple beam indications). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to transmission configuration state selection for periodic wireless communications with multiple beam indications). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of transmission configuration state selection for periodic wireless communications with multiple beam indications as described herein. For example, the communications manager 1320 may include a TCI configuration manager 1325, a periodic communication manager 1330, a TCI state selection manager 1335, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communication at a network entity in accordance with examples as disclosed herein. The TCI configuration manager 1325 may be configured as or otherwise support a means for transmitting, to a UE, control signaling identifying two or more transmission configuration indicator states that are to be applied to communications of one or more channels subsequent to a determined time. The periodic communication manager 1330 may be configured as or otherwise support a means for transmitting, to the UE, a periodic communication configuration that provides a series of resource allocations for periodic communications and a selection indication for which of the two or more transmission configuration indicator states are to be selected for the periodic communications. The TCI state selection manager 1335 may be configured as or otherwise support a means for communicating via the one or more channels according to at least one of the two or more transmission configuration indicator states based on the selection indication.

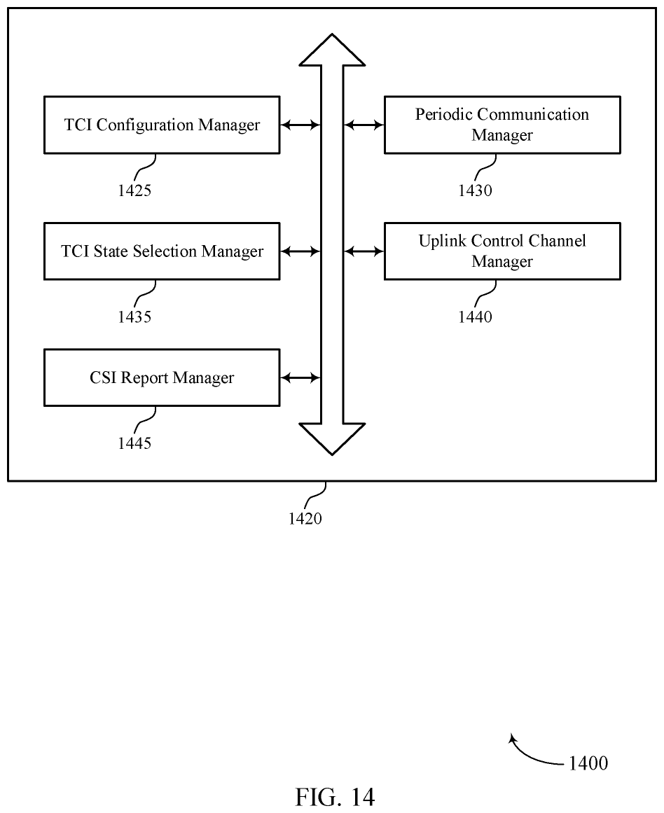

FIG. 14 shows a block diagram 1400 of a communications manager 1420 that supports transmission configuration state selection for periodic wireless communications with multiple beam indications in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of transmission configuration state selection for periodic wireless communications with multiple beam indications as described herein. For example, the communications manager 1420 may include a TCI configuration manager 1425, a periodic communication manager 1430, a TCI state selection manager 1435, an uplink control channel manager 1440, a CSI report manager 1445, or any combination thereof. Each of these components may communicate, directly or indirectly, with one another (e.g., via one or more buses).

The communications manager 1420 may support wireless communication at a network entity in accordance with examples as disclosed herein. The TCI configuration manager 1425 may be configured as or otherwise support a means for transmitting, to a UE, control signaling identifying two or more transmission configuration indicator states that are to be applied to communications of one or more channels subsequent to a determined time. The periodic communication manager 1430 may be configured as or otherwise support a means for transmitting, to the UE, a periodic communication configuration that provides a series of resource allocations for periodic communications and a selection indication for which of the two or more transmission configuration indicator states are to be selected for the periodic communications. The TCI state selection manager 1435 may be configured as or otherwise support a means for communicating via the one or more channels according to at least one of the two or more transmission configuration indicator states based on the selection indication.

In some examples, the two or more transmission configuration indicator states provide for multi-transmission reception point communications with two or more transmission reception points associated with the network entity. In some examples, the selection indication provides for selection of a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point. In some examples, both the first transmission configuration indicator state and the second transmission configuration indicator state are selected based on a multiplexing scheme or a single frequency network (SFN) scheme indicated by the periodic communication configuration. In some examples, the selection indication further indicates a pattern for applying the first transmission configuration indicator state and the second transmission configuration indicator state to different transmission layers, different resource blocks, or different time domain symbols of the multiplexing scheme.

In some examples, to support communicating, the periodic communication manager 1430 may be configured as or otherwise support a means for transmitting a downlink transmission according to at least a first transmission configuration indicator state of the two or more transmission configuration indicator states. In some examples, to support communicating, the periodic communication manager 1430 may be configured as or otherwise support a means for receiving an associated uplink transmission responsive to the downlink transmission, where the associated uplink transmission uses a same one or more transmission configuration indicator states as the downlink transmission.

In some examples, to support communicating, the periodic communication manager 1430 may be configured as or otherwise support a means for transmitting a downlink transmission according to a first transmission configuration indicator state of the two or more transmission configuration indicator states. In some examples, to support communicating, the periodic communication manager 1430 may be configured as or otherwise support a means for receiving an associated uplink transmission responsive to the downlink transmission, where the periodic communication configuration further indicates that the associated uplink transmission is to use a different transmission configuration indicator state than the downlink transmission.

In some examples, to support communicating, the periodic communication manager 1430 may be configured as or otherwise support a means for transmitting two or more downlink transmissions that have different transmission configuration indicator states of the two or more transmission configuration indicator states. In some examples, to support communicating, the TCI state selection manager 1435 may be configured as or otherwise support a means for selecting one or more transmission configuration indicator states for a first uplink communication that is associated with each of the two or more downlink transmissions based on an index value, a priority of each of the two or more downlink transmissions, or a conflict resolution rule. In some examples, to support communicating, the periodic communication manager 1430 may be configured as or otherwise support a means for receiving the first uplink communication based on the selecting.

In some examples, the selection indication for which of the two or more transmission configuration indicator states are to be selected for periodic uplink control channel communications is provided for each of one or more configured uplink control channel resources, is based on a semi-persistent scheduling configuration, a CSI report configuration, a scheduling request (SR) resource configuration, or any combinations thereof. In some examples, the selection indication for which of the two or more transmission configuration indicator states are to be selected for periodic uplink shared channel communications is based on an indication provided in a medium access control (MAC) control element that activates the periodic uplink control channel communications. In some examples, where the selection indication for which of the two or more transmission configuration indicator states are to be selected for semi-persistent CSI report on uplink shared channel communications is based on one or more of an indication associated with a CSI reporting configuration or a trigger state associated with the semi-persistent CSI report.

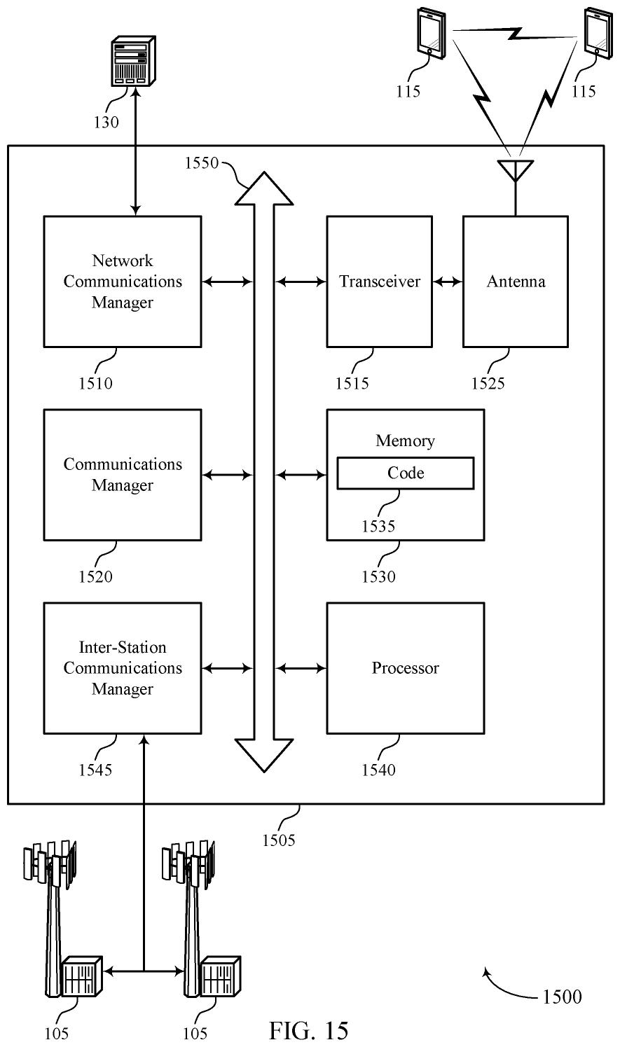

FIG. 15 shows a diagram of a system 1500 including a device 1505 that supports transmission configuration state selection for periodic wireless communications with multiple beam indications in accordance with aspects of the present disclosure. The device 1505 may be an example of or include the components of a device 1205, a device 1305, or a base station 105 as described herein. The device 1505 may communicate wirelessly with one or more base stations 105, UEs 115, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting transmission configuration state selection for periodic wireless communications with multiple beam indications). For example, the device 1505 or a component of the device 1505 may include a processor 1540 and memory 1530 coupled with or to the processor 1540, the processor 1540 and memory 1530 configured to perform various functions described herein.

The inter-station communications manager 1545 may manage communications with other base stations 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105.

The communications manager 1520 may support wireless communication at a network entity in accordance with examples as disclosed herein. For example, the communications manager 1520 may be configured as or otherwise support a means for transmitting, to a UE, control signaling identifying two or more transmission configuration indicator states that are to be applied to communications of one or more channels subsequent to a determined time. The communications manager 1520 may be configured as or otherwise support a means for transmitting, to the UE, a periodic communication configuration that provides a series of resource allocations for periodic communications and a selection indication for which of the two or more transmission configuration indicator states are to be selected for the periodic communications. The communications manager 1520 may be configured as or otherwise support a means for communicating via the one or more channels according to at least one of the two or more transmission configuration indicator states based on the selection indication.

By including or configuring the communications manager 1520 in accordance with examples as described herein, the device 1505 may support techniques for selection of one or more particular TCI states for a one or more periodic communications where multiple TCI states are configured, which may provide for reduced signaling overhead, increased flexibility, more efficient use of spatial resources, decreased collisions and interference, increased reliability of communications, and improved user experience.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of transmission configuration state selection for periodic wireless communications with multiple beam indications as described herein, or the processor 1540 and the memory 1530 may be otherwise configured to perform or support such operations.

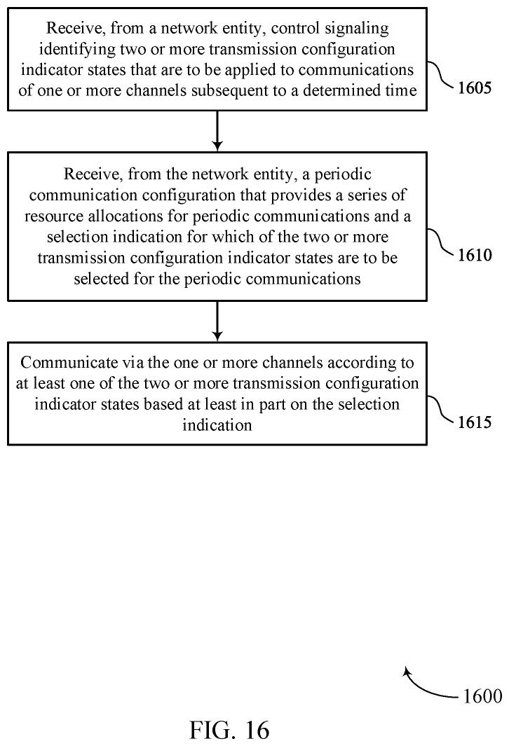

FIG. 16 shows a flowchart illustrating a method 1600 that supports transmission configuration state selection for periodic wireless communications with multiple beam indications in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include receiving, from a network entity, control signaling identifying two or more transmission configuration indicator states that are to be applied to communications of one or more channels subsequent to a determined time. The operations of 1605 may be performed in accordance with examples as disclosed herein. In some examples, aspects of the operations of 1605 may be performed by a TCI configuration manager 1025 as described with reference to FIG. 10.

At 1610, the method may include receiving, from the network entity, a periodic communication configuration that provides a series of resource allocations for periodic communications and a selection indication for which of the two or more transmission configuration indicator states are to be selected for the periodic communications. The operations of 1610 may be performed in accordance with examples as disclosed herein. In some examples, aspects of the operations of 1610 may be performed by a periodic communication manager 1030 as described with reference to FIG. 10.

At 1615, the method may include communicating via the one or more channels according to at least one of the two or more transmission configuration indicator states based on the selection indication. The operations of 1615 may be performed in accordance with examples as disclosed herein. In some examples, aspects of the operations of 1615 may be performed by a TCI state selection manager 1035 as described with reference to FIG. 10.

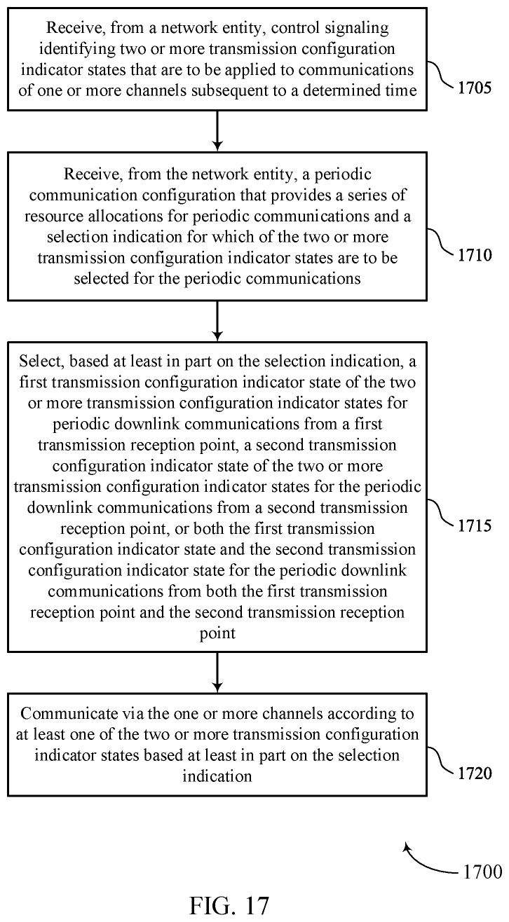

FIG. 17 shows a flowchart illustrating a method 1700 that supports transmission configuration state selection for periodic wireless communications with multiple beam indications in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1705, the method may include receiving, from a network entity, control signaling identifying two or more transmission configuration indicator states that are to be applied to communications of one or more channels subsequent to a determined time. The operations of 1705 may be performed in accordance with examples as disclosed herein. In some examples, aspects of the operations of 1705 may be performed by a TCI configuration manager 1025 as described with reference to FIG. 10.

At 1710, the method may include receiving, from the network entity, a periodic communication configuration that provides a series of resource allocations for periodic communications and a selection indication for which of the two or more transmission configuration indicator states are to be selected for the periodic communications. The operations of 1710 may be performed in accordance with examples as disclosed herein. In some examples, aspects of the operations of 1710 may be performed by a periodic communication manager 1030 as described with reference to FIG. 10.

At 1715, the method may include selecting, based on the selection indication, a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point. The operations of 1715 may be performed in accordance with examples as disclosed herein. In some examples, aspects of the operations of 1715 may be performed by a TCI state selection manager 1035 as described with reference to FIG. 10.

At 1720, the method may include communicating via the one or more channels according to at least one of the two or more transmission configuration indicator states based on the selection indication. The operations of 1720 may be performed in accordance with examples as disclosed herein. In some examples, aspects of the operations of 1720 may be performed by a TCI state selection manager 1035 as described with reference to FIG. 10.

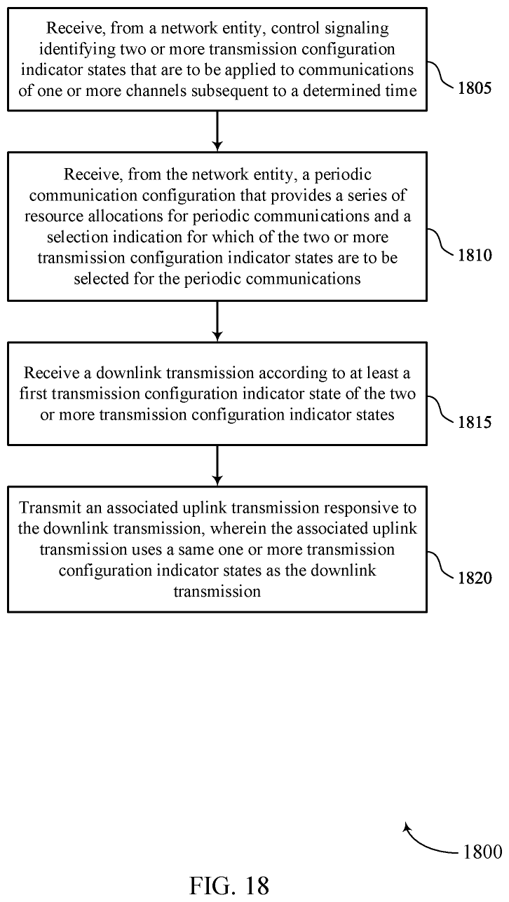

FIG. 18 shows a flowchart illustrating a method 1800 that supports transmission configuration state selection for periodic wireless communications with multiple beam indications in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1805, the method may include receiving, from a network entity, control signaling identifying two or more transmission configuration indicator states that are to be applied to communications of one or more channels subsequent to a determined time. The operations of 1805 may be performed in accordance with examples as disclosed herein. In some examples, aspects of the operations of 1805 may be performed by a TCI configuration manager 1025 as described with reference to FIG. 10.

At 1810, the method may include receiving, from the network entity, a periodic communication configuration that provides a series of resource allocations for periodic communications and a selection indication for which of the two or more transmission configuration indicator states are to be selected for the periodic communications. The operations of 1810 may be performed in accordance with examples as disclosed herein. In some examples, aspects of the operations of 1810 may be performed by a periodic communication manager 1030 as described with reference to FIG. 10.

At 1815, the method may include receiving a downlink transmission according to at least a first transmission configuration indicator state of the two or more transmission configuration indicator states. The operations of 1815 may be performed in accordance with examples as disclosed herein. In some examples, aspects of the operations of 1815 may be performed by a periodic communication manager 1030 as described with reference to FIG. 10.

At 1820, the method may include transmitting an associated uplink transmission responsive to the downlink transmission, where the associated uplink transmission uses a same one or more transmission configuration indicator states as the downlink transmission. The operations of 1820 may be performed in accordance with examples as disclosed herein. In some examples, aspects of the operations of 1820 may be performed by a periodic communication manager 1030 as described with reference to FIG. 10.

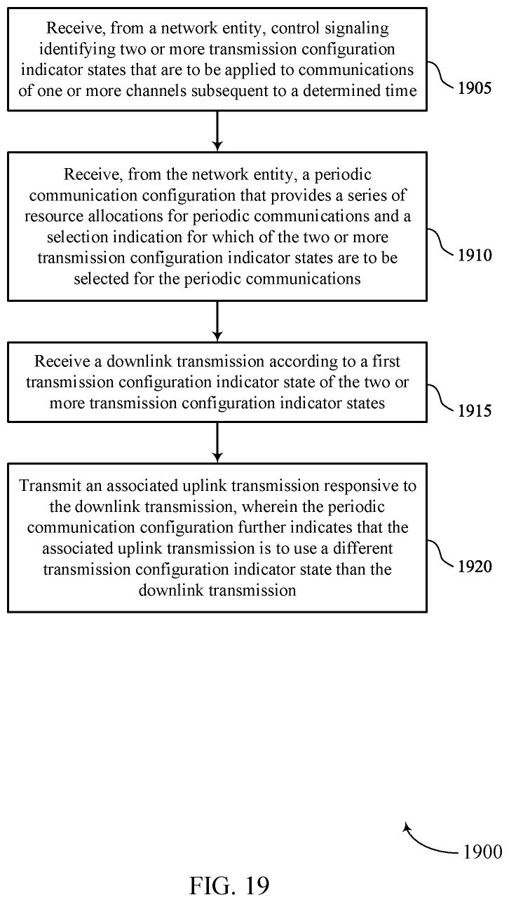

FIG. 19 shows a flowchart illustrating a method 1900 that supports transmission configuration state selection for periodic wireless communications with multiple beam indications in accordance with aspects of the present disclosure. The operations of the method 1900 may be implemented by a UE or its components as described herein. For example, the operations of the method 1900 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1905, the method may include receiving, from a network entity, control signaling identifying two or more transmission configuration indicator states that are to be applied to communications of one or more channels subsequent to a determined time. The operations of 1905 may be performed in accordance with examples as disclosed herein. In some examples, aspects of the operations of 1905 may be performed by a TCI configuration manager 1025 as described with reference to FIG. 10.

At 1910, the method may include receiving, from the network entity, a periodic communication configuration that provides a series of resource allocations for periodic communications and a selection indication for which of the two or more transmission configuration indicator states are to be selected for the periodic communications. The operations of 1910 may be performed in accordance with examples as disclosed herein. In some examples, aspects of the operations of 1910 may be performed by a periodic communication manager 1030 as described with reference to FIG. 10.

At 1915, the method may include receiving a downlink transmission according to a first transmission configuration indicator state of the two or more transmission configuration indicator states. The operations of 1915 may be performed in accordance with examples as disclosed herein. In some examples, aspects of the operations of 1915 may be performed by a periodic communication manager 1030 as described with reference to FIG. 10.

At 1920, the method may include transmitting an associated uplink transmission responsive to the downlink transmission, where the periodic communication configuration further indicates that the associated uplink transmission is to use a different transmission configuration indicator state than the downlink transmission. The operations of 1920 may be performed in accordance with examples as disclosed herein. In some examples, aspects of the operations of 1920 may be performed by a periodic communication manager 1030 as described with reference to FIG. 10.

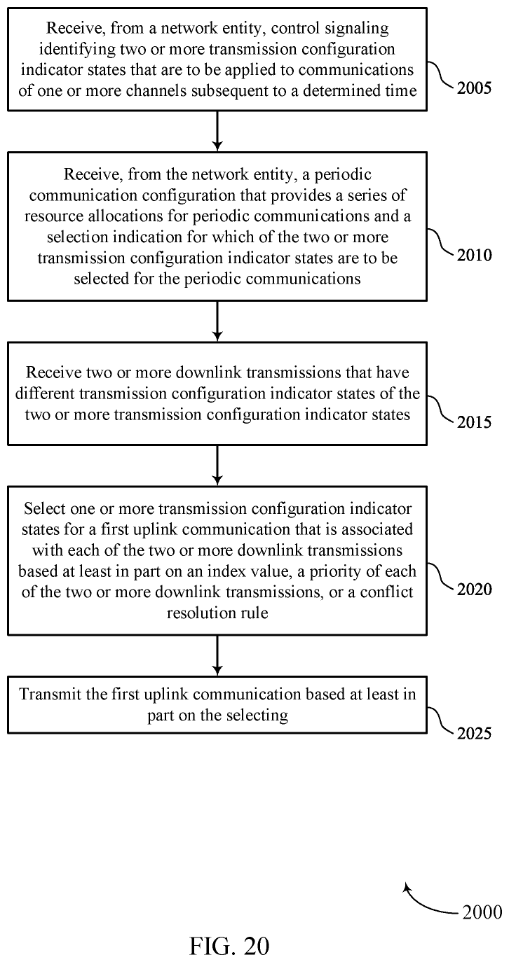

FIG. 20 shows a flowchart illustrating a method 2000 that supports transmission configuration state selection for periodic wireless communications with multiple beam indications in accordance with aspects of the present disclosure. The operations of the method 2000 may be implemented by a UE or its components as described herein. For example, the operations of the method 2000 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 2005, the method may include receiving, from a network entity, control signaling identifying two or more transmission configuration indicator states that are to be applied to communications of one or more channels subsequent to a determined time. The operations of 2005 may be performed in accordance with examples as disclosed herein. In some examples, aspects of the operations of 2005 may be performed by a TCI configuration manager 1025 as described with reference to FIG. 10.

At 2010, the method may include receiving, from the network entity, a periodic communication configuration that provides a series of resource allocations for periodic communications and a selection indication for which of the two or more transmission configuration indicator states are to be selected for the periodic communications. The operations of 2010 may be performed in accordance with examples as disclosed herein. In some examples, aspects of the operations of 2010 may be performed by a periodic communication manager 1030 as described with reference to FIG. 10.

At 2015, the method may include receiving two or more downlink transmissions that have different transmission configuration indicator states of the two or more transmission configuration indicator states. The operations of 2015 may be performed in accordance with examples as disclosed herein. In some examples, aspects of the operations of 2015 may be performed by a periodic communication manager 1030 as described with reference to FIG. 10.

At 2020, the method may include selecting one or more transmission configuration indicator states for a first uplink communication that is associated with each of the two or more downlink transmissions based on an index value, a priority of each of the two or more downlink transmissions, or a conflict resolution rule. The operations of 2020 may be performed in accordance with examples as disclosed herein. In some examples, aspects of the operations of 2020 may be performed by a TCI state selection manager 1035 as described with reference to FIG. 10.

At 2025, the method may include transmitting the first uplink communication based on the selecting. The operations of 2025 may be performed in accordance with examples as disclosed herein. In some examples, aspects of the operations of 2025 may be performed by a periodic communication manager 1030 as described with reference to FIG. 10.

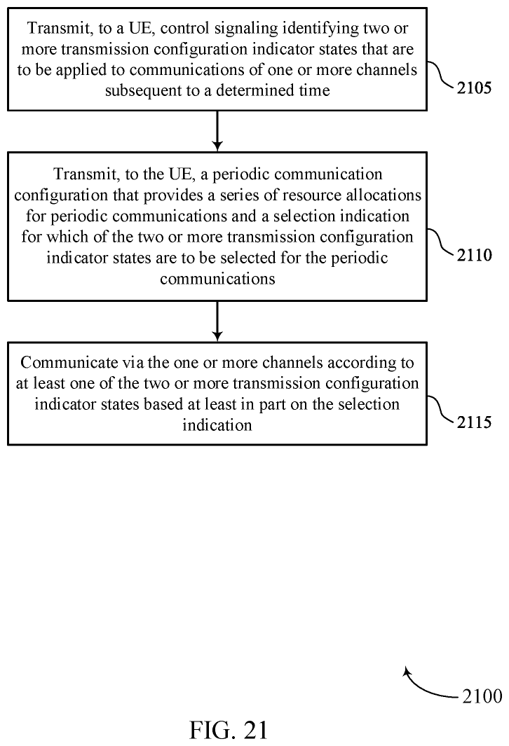

FIG. 21 shows a flowchart illustrating a method 2100 that supports transmission configuration state selection for periodic wireless communications with multiple beam indications in accordance with aspects of the present disclosure. The operations of the method 2100 may be implemented by a base station or its components as described herein. For example, the operations of the method 2100 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2105, the method may include transmitting, to a UE, control signaling identifying two or more transmission configuration indicator states that are to be applied to communications of one or more channels subsequent to a determined time. The operations of 2105 may be performed in accordance with examples as disclosed herein. In some examples, aspects of the operations of 2105 may be performed by a TCI configuration manager 1425 as described with reference to FIG. 14.

At 2110, the method may include transmitting, to the UE, a periodic communication configuration that provides a series of resource allocations for periodic communications and a selection indication for which of the two or more transmission configuration indicator states are to be selected for the periodic communications. The operations of 2110 may be performed in accordance with examples as disclosed herein. In some examples, aspects of the operations of 2110 may be performed by a periodic communication manager 1430 as described with reference to FIG. 14.

At 2115, the method may include communicating via the one or more channels according to at least one of the two or more transmission configuration indicator states based on the selection indication. The operations of 2115 may be performed in accordance with examples as disclosed herein. In some examples, aspects of the operations of 2115 may be performed by a TCI state selection manager 1435 as described with reference to FIG. 14.

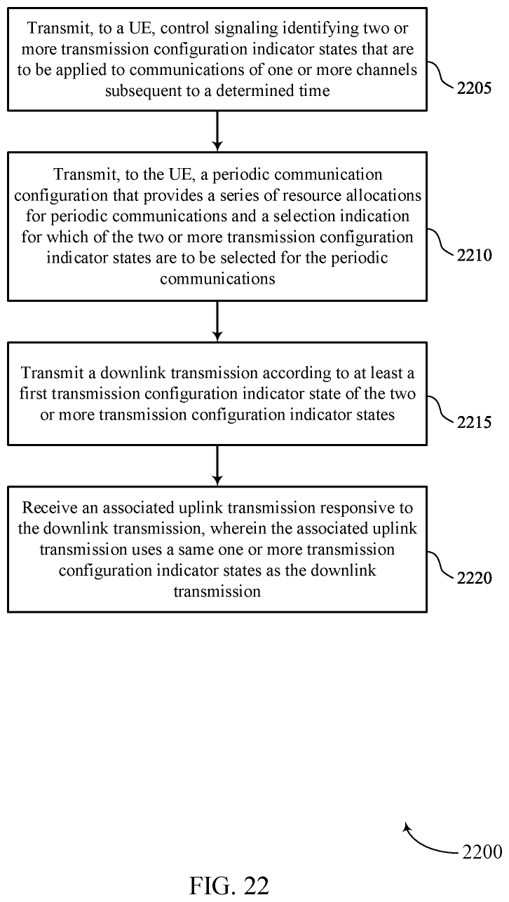

FIG. 22 shows a flowchart illustrating a method 2200 that supports transmission configuration state selection for periodic wireless communications with multiple beam indications in accordance with aspects of the present disclosure. The operations of the method 2200 may be implemented by a base station or its components as described herein. For example, the operations of the method 2200 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2205, the method may include transmitting, to a UE, control signaling identifying two or more transmission configuration indicator states that are to be applied to communications of one or more channels subsequent to a determined time. The operations of 2205 may be performed in accordance with examples as disclosed herein. In some examples, aspects of the operations of 2205 may be performed by a TCI configuration manager 1425 as described with reference to FIG. 14.

At 2210, the method may include transmitting, to the UE, a periodic communication configuration that provides a series of resource allocations for periodic communications and a selection indication for which of the two or more transmission configuration indicator states are to be selected for the periodic communications. The operations of 2210 may be performed in accordance with examples as disclosed herein. In some examples, aspects of the operations of 2210 may be performed by a periodic communication manager 1430 as described with reference to FIG. 14.

At 2215, the method may include transmitting a downlink transmission according to at least a first transmission configuration indicator state of the two or more transmission configuration indicator states. The operations of 2215 may be performed in accordance with examples as disclosed herein. In some examples, aspects of the operations of 2215 may be performed by a periodic communication manager 1430 as described with reference to FIG. 14.

At 2220, the method may include receiving an associated uplink transmission responsive to the downlink transmission, where the associated uplink transmission uses a same one or more transmission configuration indicator states as the downlink transmission. The operations of 2220 may be performed in accordance with examples as disclosed herein. In some examples, aspects of the operations of 2220 may be performed by a periodic communication manager 1430 as described with reference to FIG. 14.

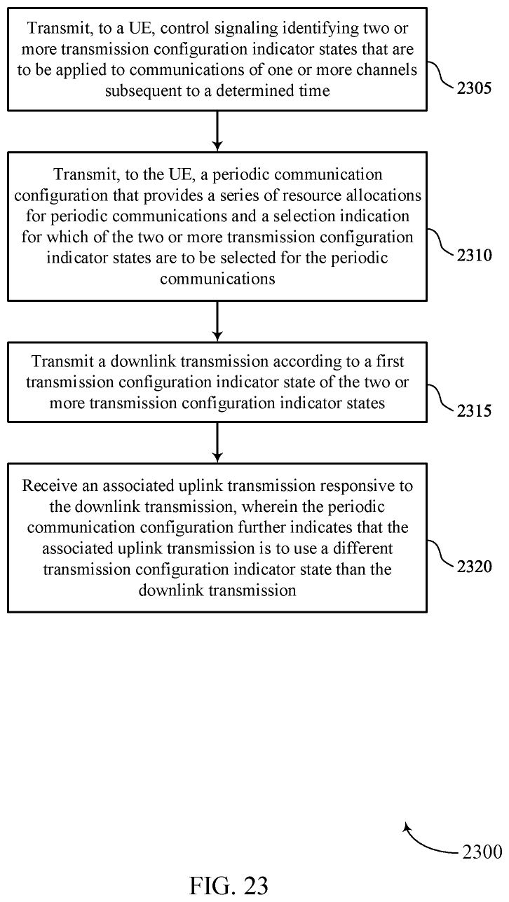

FIG. 23 shows a flowchart illustrating a method 2300 that supports transmission configuration state selection for periodic wireless communications with multiple beam indications in accordance with aspects of the present disclosure. The operations of the method 2300 may be implemented by a base station or its components as described herein. For example, the operations of the method 2300 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2305, the method may include transmitting, to a UE, control signaling identifying two or more transmission configuration indicator states that are to be applied to communications of one or more channels subsequent to a determined time. The operations of 2305 may be performed in accordance with examples as disclosed herein. In some examples, aspects of the operations of 2305 may be performed by a TCI configuration manager 1425 as described with reference to FIG. 14.

At 2310, the method may include transmitting, to the UE, a periodic communication configuration that provides a series of resource allocations for periodic communications and a selection indication for which of the two or more transmission configuration indicator states are to be selected for the periodic communications. The operations of 2310 may be performed in accordance with examples as disclosed herein. In some examples, aspects of the operations of 2310 may be performed by a periodic communication manager 1430 as described with reference to FIG. 14.

At 2315, the method may include transmitting a downlink transmission according to a first transmission configuration indicator state of the two or more transmission configuration indicator states. The operations of 2315 may be performed in accordance with examples as disclosed herein. In some examples, aspects of the operations of 2315 may be performed by a periodic communication manager 1430 as described with reference to FIG. 14.

At 2320, the method may include receiving an associated uplink transmission responsive to the downlink transmission, where the periodic communication configuration further indicates that the associated uplink transmission is to use a different transmission configuration indicator state than the downlink transmission. The operations of 2320 may be performed in accordance with examples as disclosed herein. In some examples, aspects of the operations of 2320 may be performed by a periodic communication manager 1430 as described with reference to FIG. 14.

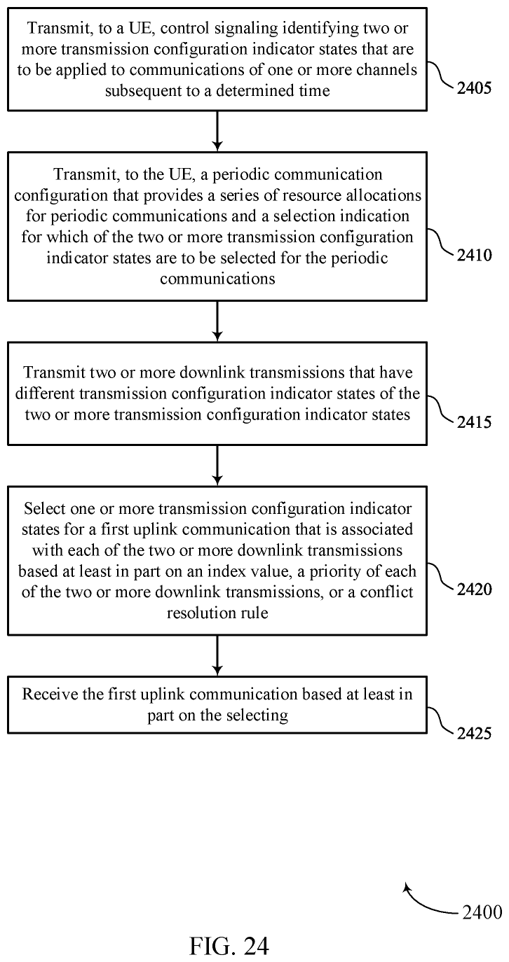

FIG. 24 shows a flowchart illustrating a method 2400 that supports transmission configuration state selection for periodic wireless communications with multiple beam indications in accordance with aspects of the present disclosure. The operations of the method 2400 may be implemented by a base station or its components as described herein. For example, the operations of the method 2400 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 2405, the method may include transmitting, to a UE, control signaling identifying two or more transmission configuration indicator states that are to be applied to communications of one or more channels subsequent to a determined time. The operations of 2405 may be performed in accordance with examples as disclosed herein. In some examples, aspects of the operations of 2405 may be performed by a TCI configuration manager 1425 as described with reference to FIG. 14.

At 2410, the method may include transmitting, to the UE, a periodic communication configuration that provides a series of resource allocations for periodic communications and a selection indication for which of the two or more transmission configuration indicator states are to be selected for the periodic communications. The operations of 2410 may be performed in accordance with examples as disclosed herein. In some examples, aspects of the operations of 2410 may be performed by a periodic communication manager 1430 as described with reference to FIG. 14.

At 2415, the method may include transmitting two or more downlink transmissions that have different transmission configuration indicator states of the two or more transmission configuration indicator states. The operations of 2415 may be performed in accordance with examples as disclosed herein. In some examples, aspects of the operations of 2415 may be performed by a periodic communication manager 1430 as described with reference to FIG. 14.

At 2420, the method may include selecting one or more transmission configuration indicator states for a first uplink communication that is associated with each of the two or more downlink transmissions based on an index value, a priority of each of the two or more downlink transmissions, or a conflict resolution rule. The operations of 2420 may be performed in accordance with examples as disclosed herein. In some examples, aspects of the operations of 2420 may be performed by a TCI state selection manager 1435 as described with reference to FIG. 14.

At 2425, the method may include receiving the first uplink communication based on the selecting. The operations of 2425 may be performed in accordance with examples as disclosed herein. In some examples, aspects of the operations of 2425 may be performed by a periodic communication manager 1430 as described with reference to FIG. 14.

The following provides an overview of aspects of the present disclosure:

Aspect 1: A method for wireless communication at a UE, comprising: receiving, from a network entity, control signaling identifying two or more transmission configuration indicator states that are to be applied to communications of one or more channels subsequent to a determined time; receiving, from the network entity, a periodic communication configuration that provides a series of resource allocations for periodic communications and a selection indication for which of the two or more transmission configuration indicator states are to be selected for the periodic communications; and communicating via the one or more channels according to at least one of the two or more transmission configuration indicator states based at least in part on the selection indication.

Aspect 2: The method of aspect 1, wherein the two or more transmission configuration indicator states provide for multi-transmission reception point communications with two or more transmission reception points associated with the network entity.

Aspect 3: The method of any of aspects 1 through 2, further comprising: selecting, based at least in part on the selection indication, a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point.

Aspect 4: The method of aspect 3, wherein the selecting is further based at least in part on a multiplexing scheme or a single frequency network (SFN) scheme indicated by the periodic communication configuration.

Aspect 5: The method of aspect 4, wherein the selection indication further indicates a pattern for applying the first transmission configuration indicator state and the second transmission configuration indicator state to different transmission layers, different resource blocks, or different time domain symbols of the multiplexing scheme.

Aspect 6: The method of any of aspects 1 through 5, wherein the communicating further comprises: receiving a downlink transmission according to at least a first transmission configuration indicator state of the two or more transmission configuration indicator states; and transmitting an associated uplink transmission responsive to the downlink transmission, wherein the associated uplink transmission uses a same one or more transmission configuration indicator states as the downlink transmission.

Aspect 7: The method of any of aspects 1 through 5, wherein the communicating further comprises: receiving a downlink transmission according to a first transmission configuration indicator state of the two or more transmission configuration indicator states; and transmitting an associated uplink transmission responsive to the downlink transmission, wherein the periodic communication configuration further indicates that the associated uplink transmission is to use a different transmission configuration indicator state than the downlink transmission.

Aspect 8: The method of any of aspects 1 through 7, wherein the communicating further comprises: receiving two or more downlink transmissions that have different transmission configuration indicator states of the two or more transmission configuration indicator states; selecting one or more transmission configuration indicator states for a first uplink communication that is associated with each of the two or more downlink transmissions based at least in part on an index value, a priority of each of the two or more downlink transmissions, or a conflict resolution rule; and transmitting the first uplink communication based at least in part on the selecting.

Aspect 9: The method of any of aspects 1 through 8, wherein the selection indication for which of the two or more transmission configuration indicator states are to be selected for periodic uplink control channel communications is provided for each of one or more configured uplink control channel resources.

Aspect 10: The method of any of aspects 1 through 9, wherein the selection indication for which of the two or more transmission configuration indicator states are to be selected for periodic uplink control channel communications is based at least in part on a semi-persistent scheduling configuration, a CSI report configuration, a scheduling request (SR) resource configuration, or any combinations thereof.

Aspect 11: The method of any of aspects 1 through 10, wherein the selection indication for which of the two or more transmission configuration indicator states are to be selected for periodic uplink control channel communications is based at least in part on an indication provided in a medium access control (MAC) control element that activates the periodic uplink control channel communications.

Aspect 12: The method of any of aspects 1 through 11, wherein the selection indication for which of the two or more transmission configuration indicator states are to be selected for periodic uplink shared channel communications is based at least in part on an indication provided in configuration information for a configured grant that allocates resources for the periodic uplink shared channel communications.

Aspect 13: The method of any of aspects 1 through 12, wherein the selection indication for which of the two or more transmission configuration indicator states are to be selected for semi-persistent CSI report on uplink shared channel communications is based at least in part on one or more of an indication associated with a CSI reporting configuration or a trigger state associated with the semi-persistent CSI report.

Aspect 14: A method for wireless communication at a network entity, comprising: transmitting, to a UE, control signaling identifying two or more transmission configuration indicator states that are to be applied to communications of one or more channels subsequent to a determined time; transmitting, to the UE, a periodic communication configuration that provides a series of resource allocations for periodic communications and a selection indication for which of the two or more transmission configuration indicator states are to be selected for the periodic communications; and communicating via the one or more channels according to at least one of the two or more transmission configuration indicator states based at least in part on the selection indication.

Aspect 15: The method of aspect 14, wherein the two or more transmission configuration indicator states provide for multi-transmission reception point communications with two or more transmission reception points associated with the network entity.

Aspect 16: The method of any of aspects 14 through 15, wherein the selection indication provides for selection of a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point.

Aspect 17: The method of aspect 16, wherein both the first transmission configuration indicator state and the second transmission configuration indicator state are selected based at least in part on a multiplexing scheme or a single frequency network (SFN) scheme indicated by the periodic communication configuration.

Aspect 18: The method of aspect 17, wherein the selection indication further indicates a pattern for applying the first transmission configuration indicator state and the second transmission configuration indicator state to different transmission layers, different resource blocks, or different time domain symbols of the multiplexing scheme.

Aspect 19: The method of any of aspects 14 through 18, wherein the communicating further comprises: transmitting a downlink transmission according to at least a first transmission configuration indicator state of the two or more transmission configuration indicator states; and receiving an associated uplink transmission responsive to the downlink transmission, wherein the associated uplink transmission uses a same one or more transmission configuration indicator states as the downlink transmission.

Aspect 20: The method of any of aspects 14 through 19, wherein the communicating further comprises: transmitting a downlink transmission according to a first transmission configuration indicator state of the two or more transmission configuration indicator states; and receiving an associated uplink transmission responsive to the downlink transmission, wherein the periodic communication configuration further indicates that the associated uplink transmission is to use a different transmission configuration indicator state than the downlink transmission.

Aspect 21: The method of any of aspects 14 through 20, wherein the communicating further comprises: transmitting two or more downlink transmissions that have different transmission configuration indicator states of the two or more transmission configuration indicator states; selecting one or more transmission configuration indicator states for a first uplink communication that is associated with each of the two or more downlink transmissions based at least in part on an index value, a priority of each of the two or more downlink transmissions, or a conflict resolution rule; and receiving the first uplink communication based at least in part on the selecting.

Aspect 22: The method of any of aspects 14 through 21, wherein the selection indication for which of the two or more transmission configuration indicator states are to be selected for periodic uplink control channel communications is provided for each of one or more configured uplink control channel resources, is based at least in part on a semi-persistent scheduling configuration, a CSI report configuration, a scheduling request (SR) resource configuration, or any combinations thereof.

Aspect 23: The method of any of aspects 14 through 22, further comprising: the selection indication for which of the two or more transmission configuration indicator states are to be selected for periodic uplink shared channel communications is based at least in part on an indication provided in a medium access control (MAC) control element that activates the periodic uplink control channel communications, and wherein the selection indication for which of the two or more transmission configuration indicator states are to be selected for semi-persistent CSI report on uplink shared channel communications is based at least in part on one or more of an indication associated with a CSI reporting configuration or a trigger state associated with the semi-persistent CSI report.

Aspect 24: An apparatus for wireless communication at a UE, comprising at least one processor; and memory coupled with the at least one processor, the memory storing instructions executable by the at least one processor to cause the apparatus to perform a method of any of aspects 1 through 13.

Aspect 25: An apparatus for wireless communication at a UE, comprising at least one means for performing a method of any of aspects 1 through 13.

Aspect 26: A non-transitory computer-readable medium storing code for wireless communication at a UE, the code comprising instructions executable by a processor to perform a method of any of aspects 1 through 13.

Aspect 27: An apparatus for wireless communication at a network entity, comprising at least one processor; and memory coupled with the at least one processor, the memory storing instructions executable by the at least one processor to cause the apparatus to perform a method of any of aspects 14 through 23.

Aspect 28: An apparatus for wireless communication at a network entity, comprising at least one means for performing a method of any of aspects 14 through 23.

Aspect 29: A non-transitory computer-readable medium storing code for wireless communication at a network entity, the code comprising instructions executable by a processor to perform a method of any of aspects 14 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network entity, control signaling identifying two or more transmission configuration indicator states that are to be applied to communications of one or more channels subsequent to a determined time;
receiving, from the network entity, a periodic communication configuration that provides a series of resource allocations for periodic communications and a selection indication for which of the two or more transmission configuration indicator states are to be selected for the periodic communications; and
communicating via the one or more channels according to at least one of the two or more transmission configuration indicator states based at least in part on the selection indication.

2. The method of claim 1, wherein the two or more transmission configuration indicator states provide for multi-transmission reception point communications with two or more transmission reception points associated with the network entity.

3. The method of claim 1, further comprising:
selecting, based at least in part on the selection indication, a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point.

4. The method of claim 3, wherein the selecting is further based at least in part on a multiplexing scheme or a single frequency network (SFN) scheme indicated by the periodic communication configuration.

5. The method of claim 4, wherein the selection indication further indicates a pattern for applying the first transmission configuration indicator state and the second transmission configuration indicator state to different transmission layers, different resource blocks, or different time domain symbols of the multiplexing scheme.

6. The method of claim 1, wherein the communicating further comprises:
receiving a downlink transmission according to at least a first transmission configuration indicator state of the two or more transmission configuration indicator states; and
transmitting an associated uplink transmission responsive to the downlink transmission, wherein the associated uplink transmission uses a same one or more transmission configuration indicator states as the downlink transmission.

7. The method of claim 1, wherein the communicating further comprises:
receiving a downlink transmission according to a first transmission configuration indicator state of the two or more transmission configuration indicator states; and
transmitting an associated uplink transmission responsive to the downlink transmission, wherein the periodic communication configuration further indicates that the associated uplink transmission is to use a different transmission configuration indicator state than the downlink transmission.

8. The method of claim 1, wherein the communicating further comprises:
receiving two or more downlink transmissions that have different transmission configuration indicator states of the two or more transmission configuration indicator states;
selecting one or more transmission configuration indicator states for a first uplink communication that is associated with each of the two or more downlink transmissions based at least in part on an index value, a priority of each of the two or more downlink transmissions, or a conflict resolution rule; and
transmitting the first uplink communication based at least in part on the selecting.

9. The method of claim 1, wherein the selection indication for which of the two or more transmission configuration indicator states are to be selected for periodic uplink control channel communications is provided for each of one or more configured uplink control channel resources.

10. The method of claim 1, wherein the selection indication for which of the two or more transmission configuration indicator states are to be selected for periodic uplink control channel communications is based at least in part on a semi-persistent scheduling configuration, a channel state information (CSI) report configuration, a scheduling request (SR) resource configuration, or any combinations thereof.

11. The method of claim 1, wherein the selection indication for which of the two or more transmission configuration indicator states are to be selected for periodic uplink control channel communications is based at least in part on an indication provided in a medium access control (MAC) control element that activates the periodic uplink control channel communications.

12. The method of claim 1, wherein the selection indication for which of the two or more transmission configuration indicator states are to be selected for periodic uplink shared channel communications is based at least in part on an indication provided in configuration information for a configured grant that allocates resources for the periodic uplink shared channel communications.

13. The method of claim 1, wherein the selection indication for which of the two or more transmission configuration indicator states are to be selected for semi-persistent channel state information (CSI) report on uplink shared channel communications is based at least in part on one or more of an indication associated with a CSI reporting configuration or a trigger state associated with the semi-persistent CSI report.

14. A method for wireless communication at a network entity, comprising:
transmitting, to a user equipment (UE), control signaling identifying two or more transmission configuration indicator states that are to be applied to communications of one or more channels subsequent to a determined time;
transmitting, to the UE, a periodic communication configuration that provides a series of resource allocations for periodic communications and a selection indication for which of the two or more transmission configuration indicator states are to be selected for the periodic communications; and
communicating via the one or more channels according to at least one of the two or more transmission configuration indicator states based at least in part on the selection indication.

15. The method of claim 14, wherein the two or more transmission configuration indicator states provide for multi-transmission reception point communications with two or more transmission reception points associated with the network entity.

16. The method of claim 14, wherein the selection indication provides for selection of a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point.

17. The method of claim 16, wherein both the first transmission configuration indicator state and the second transmission configuration indicator state are selected based at least in part on a multiplexing scheme or a single frequency network (SFN) scheme indicated by the periodic communication configuration.

18. The method of claim 17, wherein the selection indication further indicates a pattern for applying the first transmission configuration indicator state and the second transmission configuration indicator state to different transmission layers, different resource blocks, or different time domain symbols of the multiplexing scheme.

19. The method of claim 14, wherein the communicating further comprises:
transmitting a downlink transmission according to at least a first transmission configuration indicator state of the two or more transmission configuration indicator states; and
receiving an associated uplink transmission responsive to the downlink transmission, wherein the associated uplink transmission uses a same one or more transmission configuration indicator states as the downlink transmission.

20. The method of claim 14, wherein the communicating further comprises:
transmitting a downlink transmission according to a first transmission configuration indicator state of the two or more transmission configuration indicator states; and
receiving an associated uplink transmission responsive to the downlink transmission, wherein the periodic communication configuration further indicates that the associated uplink transmission is to use a different transmission configuration indicator state than the downlink transmission.

21. The method of claim 14, wherein the communicating further comprises:
transmitting two or more downlink transmissions that have different transmission configuration indicator states of the two or more transmission configuration indicator states;
selecting one or more transmission configuration indicator states for a first uplink communication that is associated with each of the two or more downlink transmissions based at least in part on an index value, a priority of each of the two or more downlink transmissions, or a conflict resolution rule; and
receiving the first uplink communication based at least in part on the selecting.

22. The method of claim 14, wherein the selection indication for which of the two or more transmission configuration indicator states are to be selected for periodic uplink control channel communications is provided for each of one or more configured uplink control channel resources, is based at least in part on a semi-persistent scheduling configuration, a channel state information (CSI) report configuration, a scheduling request (SR) resource configuration, or any combinations thereof.

23. The method of claim 14, wherein:
the selection indication for which of the two or more transmission configuration indicator states are to be selected for periodic uplink shared channel communications is based at least in part on an indication provided in a medium access control (MAC) control element that activates the periodic uplink shared channel communications, or
wherein the selection indication for which of the two or more transmission configuration indicator states are to be selected for semi-persistent channel state information (CSI) report on uplink shared channel communications is based at least in part on one or more of an indication associated with a CSI reporting configuration or a trigger state associated with the semi-persistent CSI report.

24. An apparatus for wireless communication at a user equipment (UE), comprising:
at least one processor; and
memory coupled to the at least one processor, the memory storing instructions executable by the at least one processor to cause the apparatus to:
receive, from a network entity, control signaling identifying two or more transmission configuration indicator states that are to be applied to communications of one or more channels subsequent to a determined time;
receive, from the network entity, a periodic communication configuration that provides a series of resource allocations for periodic communications and a selection indication for which of the two or more transmission configuration indicator states are to be selected for the periodic communications; and
communicate via the one or more channels according to at least one of the two or more transmission configuration indicator states based at least in part on the selection indication.

25. The apparatus of claim 24, wherein the instructions are further executable by the processor to cause the apparatus to:
select, based at least in part on the selection indication, a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point.

26. The apparatus of claim 24, wherein the instructions to communicate are further executable by the processor to cause the apparatus to:
receive a downlink transmission according to at least a first transmission configuration indicator state of the two or more transmission configuration indicator states; and
transmit an associated uplink transmission responsive to the downlink transmission, wherein the associated uplink transmission uses a same one or more transmission configuration indicator states as the downlink transmission.

27. The apparatus of claim 24, wherein the instructions to communicate are further executable by the processor to cause the apparatus to:
receive a downlink transmission according to a first transmission configuration indicator state of the two or more transmission configuration indicator states; and
transmit an associated uplink transmission responsive to the downlink transmission, wherein the periodic communication configuration further indicates that the associated uplink transmission is to use a different transmission configuration indicator state than the downlink transmission.

28. An apparatus for wireless communication at a network entity, comprising:
at least one processor; and
memory coupled to the at least one processor, the memory storing instructions executable by the at least one processor to cause the apparatus to:
transmit, to a user equipment (UE), control signaling identifying two or more transmission configuration indicator states that are to be applied to communications of one or more channels subsequent to a determined time;
transmit, to the UE, a periodic communication configuration that provides a series of resource allocations for periodic communications and a selection indication for which of the two or more transmission configuration indicator states are to be selected for the periodic communications; and
communicate via the one or more channels according to at least one of the two or more transmission configuration indicator states based at least in part on the selection indication.

29. The apparatus of claim 28, wherein the selection indication provides for selection of a first transmission configuration indicator state of the two or more transmission configuration indicator states for periodic downlink communications from a first transmission reception point, a second transmission configuration indicator state of the two or more transmission configuration indicator states for the periodic downlink communications from a second transmission reception point, or both the first transmission configuration indicator state and the second transmission configuration indicator state for the periodic downlink communications from both the first transmission reception point and the second transmission reception point.

30. The apparatus of claim 28, wherein the instructions to communicate are further executable by the processor to cause the apparatus to:
transmit a downlink transmission according to at least a first transmission configuration indicator state of the two or more transmission configuration indicator states; and
receive an associated uplink transmission responsive to the downlink transmission, wherein the associated uplink transmission uses a same one or more transmission configuration indicator states as the downlink transmission.
